(19) United States
(12) Patent Application Publication
(10) Pub. No.: US 2026/0346140 A1
(43) Pub. Date: Nov. 5, 2026

(54) BATTLE INTERFACE DISPLAY METHOD AND APPARATUS, COMPUTER DEVICE, AND STORAGE MEDIUM

(71) Applicant: Tencent Technology (Shenzhen) Company Limited., Shenzhen (CN)

(72) Inventor: Wei HUANG, Shenzhen (CN)

(21) Appl. No.: 19/711,611

(22) Filed: Jun. 17, 2026

Related U.S. Application Data
(63) Continuation of application No. PCT/CN2025/075838, filed on Feb. 5, 2025.

(30) Foreign Application Priority Data
Feb. 8, 2024 (CN) 202410178247.6

(51) Int. Cl. A63F 13/52; A63F 13/58; A63F 13/792

(52) U.S. Cl. CPC A63F 13/52; A63F 13/58; A63F 13/792

(57) ABSTRACT

Disclosed is a battle interface display method performed by a computer device. The method includes: displaying a battle interface of a round-based board game, the battle interface comprising a virtual board and a player character display area including a virtual player character, and a first virtual piece of the virtual player character being displayed on the virtual board; in response to a dragging operation on the first virtual piece, rendering a first animation in which the virtual player character drags the first virtual piece through a target prop in the player character display area in parallel to the target prop dragging the first virtual piece on the virtual board; and displaying, in response to an end of the dragging operation, the first virtual piece placed at a first position, the first position being a position at which the dragging operation ends.

### CROSS-REFERENCE TO RELATED APPLICATIONS

This application is a continuation application of PCT Patent Application No. PCT/CN2025/075838, entitled “BATTLE INTERFACE DISPLAY METHOD AND APPARATUS, COMPUTER DEVICE, AND STORAGE MEDIUM” filed on Feb. 5, 2025, which claims priority to Chinese Patent Application No. 202410178247.6, entitled “BATTLE INTERFACE DISPLAY METHOD AND APPARATUS, COMPUTER DEVICE, AND STORAGE MEDIUM” filed on Feb. 8, 2024, both of which are incorporated herein by reference in their entirety.

### FIELD OF THE TECHNOLOGY

Embodiments of this application relate to the technical field of computers, and in particular, to a battle interface display method and apparatus, a computer device, and a storage medium.

### BACKGROUND OF THE DISCLOSURE

A round-based board game is a multiplayer competitive board game, in which after two sides of a battle place pieces on a virtual board, a game application automatically controls the pieces on the virtual board to battle against each other, displays a battle result, deducts health points from a losing side, and finally determines the battle ranking according to the elimination order.

### SUMMARY

Embodiments of this application provide a battle interface display method and apparatus, a computer device, and a storage medium, which can improve an interaction effect between a virtual player character and a player. Technical solutions are as follows.

According to one aspect, a battle interface display method is performed by a computer device, the method including:
displaying a battle interface of a round-based board game, the battle interface comprising a virtual board and a player character display area including a virtual player character, and a first virtual piece of the virtual player character being displayed on the virtual board;
in response to a dragging operation on the first virtual piece, rendering a first animation in which the virtual player character drags the first virtual piece through a target prop in the player character display area in parallel to the target prop dragging the first virtual piece on the virtual board; and
displaying, in response to an end of the dragging operation, the first virtual piece at a first position of the virtual board, the first position being a position at which the dragging operation ends.

According to another aspect, a computer device is provided, including a processor and a memory, the memory having at least one computer program stored therein, and the at least one computer program, when being loaded and executed by the processor, causing the computer device to implement the operations performed in the battle interface display method according to the foregoing aspects.

According to another aspect, a non-transitory computer-readable storage medium is provided, having at least one computer program stored therein, and the at least one computer program, when being loaded and executed by a processor of a computer device, causing the computer device to implement operations performed in the battle interface display method according to the foregoing aspects.

In the solutions provided in the embodiments of this application, in response to the dragging operation on the virtual piece on the virtual board, a picture in which the virtual player character drags the virtual piece through a prop can be displayed, so as to reflect the solution in which the virtual player character adjusts the virtual piece layout in the virtual board through the target prop. Movement of the virtual pieces can precisely follow operations of the player, thereby reducing stuttering and delay, providing the player with an exceptionally smooth operational experience, and significantly improving the efficiency of controlling the virtual piece by the player. In addition, the sense of participation of the virtual player character in the process of adjusting the virtual piece layout is enhanced, so that the player can adjust the position of the virtual piece on the virtual board by acting as the virtual player character, thereby improving the interaction effect between the virtual player character and the player, enhancing the sense of immersion of the player, and further improving the player experience.

### BRIEF DESCRIPTION OF THE DRAWINGS

FIG. 1 is a structural block diagram of a computer system according to an embodiment of this application.

FIG. 2 is a flowchart of a battle interaction method for a round-based board game according to an embodiment of this application.

FIG. 3 is a schematic interface diagram of a battle interface of a round-based board game according to an embodiment of this application.

FIG. 4 is a schematic card diagram of a piece card according to an embodiment of this application.

FIG. 5 is a schematic card diagram of an effect card according to an embodiment of this application.

FIG. 6 is a schematic card diagram of an equipment card according to an embodiment of this application.

FIG. 7 is a schematic card diagram of a player character card according to an embodiment of this application.

FIG. 8 is a flowchart of a battle interaction method for a round-based board game according to an embodiment of this application.

FIG. 9 is a schematic interface diagram of a player character selection interface according to an embodiment of this application.

FIG. 10 is a schematic interface diagram of a battle interface at a preparation phase according to an embodiment of this application.

FIG. 11 is a schematic interface diagram showing a card being played at a preparation phase according to an embodiment of this application.

FIG. 12 is a schematic diagram of an upgrade process of an upgrade button according to an embodiment of this application.

FIG. 13 is a schematic diagram of an automatic battle according to an embodiment of this application.

FIG. 14 is a schematic interface diagram of a battle interface at a battle phase according to an embodiment of this application.

FIG. 15 is a schematic interface diagram of a settlement interface according to an embodiment of this application.

FIG. 16 is a flowchart of a battle interface display method according to an embodiment of this application.

FIG. 17 is a flowchart of another battle interface display method according to an embodiment of this application.

FIG. 18 is a schematic interface diagram of a battle interface according to an embodiment of this application.

FIG. 19 is a flowchart of yet another battle interface display method according to an embodiment of this application.

FIG. 20 is a flowchart of dragging a virtual piece according to an embodiment of this application.

FIG. 21 is another flowchart of dragging a virtual piece according to an embodiment of this application.

FIG. 22 is a schematic structural diagram of a battle interface display apparatus according to an embodiment of this application.

FIG. 23 is a schematic structural diagram of another battle interface display apparatus according to an embodiment of this application.

FIG. 24 is a schematic structural diagram of a terminal according to an embodiment of this application.

FIG. 25 is a schematic structural diagram of a server according to an embodiment of this application.

### DESCRIPTION OF EMBODIMENTS

The terms “first”, “second”, “third”, “fourth”, “fifth”, “sixth”, and the like used in this application may be used for describing various concepts in this specification. However, the concepts are not limited by the terms unless otherwise specified. These terms are merely used for distinguishing a concept from another concept. For example, without departing from the scope of this application, a first virtual piece may be referred to as a second virtual piece, and similarly, the second virtual piece may be referred to as the first virtual piece.

In terms of “at least one”, “a plurality of”, “each”, and “any one” used in this application, “at least one” includes one, two, or more, “a plurality of” includes two or more, “each” refers to each of a plurality of corresponding items, and “any one” refers to any one of a plurality of items. For example, a plurality of virtual pieces include three virtual pieces, each refers to each of the three virtual pieces, any refers to any one of the three virtual pieces, which can be a first virtual piece, a second virtual piece, or a third virtual piece.

Information (including, but not limited to, user device information, user personal information, and the like), data (including, but not limited to, data for analysis, data for storage, data for displaying, and the like), and signals involved in this application are all authorized by users or fully authorized by all parties, and collection, use, and processing of relevant data need to comply with relevant laws, regulations, and standards of relevant countries and regions. For example, the virtual card and game-related data involved in this application are all acquired under full authorization.

In the related art, a position of a virtual piece on a virtual board can be adjusted before a battle starts, but an interaction effect of a current solution for adjusting the position of the virtual piece is poor.

First, terms involved in the embodiments of this application are introduced.

A round-based board game refers to a board game in which “virtual pieces” are laid out in advance before a battle, and during the battle, the “virtual pieces” can automatically battle according to the preset layout. A “virtual piece” is usually represented by a virtual character, and for example, may be referred to as a virtual hero. During the battle, the virtual character automatically casts various skills for battling. The battle is usually conducted in a round-based manner. When all “virtual pieces” of one battling side are eliminated (that is, health points of virtual characters decrease to zero), the side is the losing side of the battle in the current turn. In some embodiments, in addition to having “virtual piece-type virtual characters” for battling, two sides of the battle are each provided with a player character representing a current user participating in the battle. The player character cannot be moved to a battle region or a virtual piece candidate area as a “virtual piece”. The player character is also provided with a health point (or blood volume). The health point of the player character is correspondingly reduced (a battle fails) or not changed (a battle wins) according to a battle result of each turn. When the health point of the player character decreases to zero, the user corresponding to the player character exits the battle, and the remaining users continue the battle. In some embodiments, the round-based board game includes an auto battler game.

The auto battler game is a round-based multiplayer competitive game featuring in-game collectible hero virtual pieces. For example, there are eight or six players in a game, each occupying a region on the board. In each turn, a plurality of players are grouped in pairs, each group includes two players, and two players belonging to the same group engage in a one-on-one battle. Each turn of the battle contains two phases: a preparation phase and a battle phase. In the preparation phase, the user purchases virtual pieces (heroes) from a shop and arranges them on the board. In the battle phase, two sides' lineups are locked, and the virtual pieces battle automatically until all virtual pieces of one side are eliminated. The side whose virtual pieces are entirely eliminated is the losing side of the current turn and incurs a deduction of blood volumes. The game turns are continuously repeated, with new opponents matched, until the player's health points drop to ≤0, at which point the player is eliminated. The last remaining player wins the game (ranked first).

A board refers to a region in a round-based board game battle interface that is configured for preparing and conducting battles. The board may be any one of a two-dimensional virtual board, a 2.5-dimensional virtual board, and a three-dimensional (3D) virtual board. This is not limited in this application.

A board of the conventional auto battler game is divided into a battle region and a virtual piece candidate area. The battle region includes several tiles having a same size, and the tiles are configured for placing virtual pieces for battling in a battle process. The virtual piece candidate area includes several candidate virtual piece positions, and the candidate virtual piece positions are configured for placing candidate virtual pieces. The candidate virtual piece does not participate in the battle in the battle process and may be dragged and placed in the battle region in the preparation phase. The board region provided in this embodiment of this application does not include the virtual piece candidate area and only includes the battle region.

Regarding the arrangement of tiles in the battle region, in some embodiments, the battle region includes n (rows)×m (columns) tiles. Exemplarily, n is an integer multiple of 2, and two adjacent rows of tiles are aligned or staggered. In addition, the battle region is equally divided into two parts according to rows, which are a current player's battle region and an opposing player's battle region, respectively. Users participating in the battle are located on upper and lower sides of the battle interface. In the preparation phase, the users can place virtual pieces only in the current player's battle region. In other embodiments, the battle region is equally divided into two parts according to columns, which are a current player's battle region and an opposing player's battle region, respectively. Users participating in the battle are located on left and right sides or upper and lower sides of the battle interface. The shape of the tile may be any one of a square, a rectangle, a circle, and a hexagon. The shape of the tile is not limited in this embodiment of this application.

A virtual card is a common term of a game type, and derives from a tabletop game. Unlike directly manipulating a virtual piece model, the virtual card carries game content on the card itself. Compared with the virtual piece, the virtual card is more convenient for carrying some text descriptions, virtual card attribute information, and transmission of some key values. “Cardification” refers to converting hero resources into card resources, thereby facilitating players' reading and classification of card effects, and enabling multi-dimensional information transmission.

Energy is a resource manner of a game. However, in this application, the energy is defined as a resource for a player to play a card. When a virtual card is played, energy of a corresponding value marked on the virtual card needs to be consumed.

Virtual equipment: in an auto battler game three pieces of virtual equipment (or other pieces of virtual equipment) may be equipped on each virtual piece, and the virtual equipment may provide attributes or effects such as attack power, defense power, health points, healing, penetration, and shields to the hero. An auto battler game in the related art usually has a creep turn. Players obtain virtual equipment dropped by creeps by defeating them and collect the virtual equipment into their backpacks. Virtual equipment may alternatively be synthesized from individual components to form higher-rarity virtual equipment.

A player character is a virtual character played by a player, and is alternatively referred to as a virtual player character. Each player character has a different special ability, which can help the player perform better in the game.

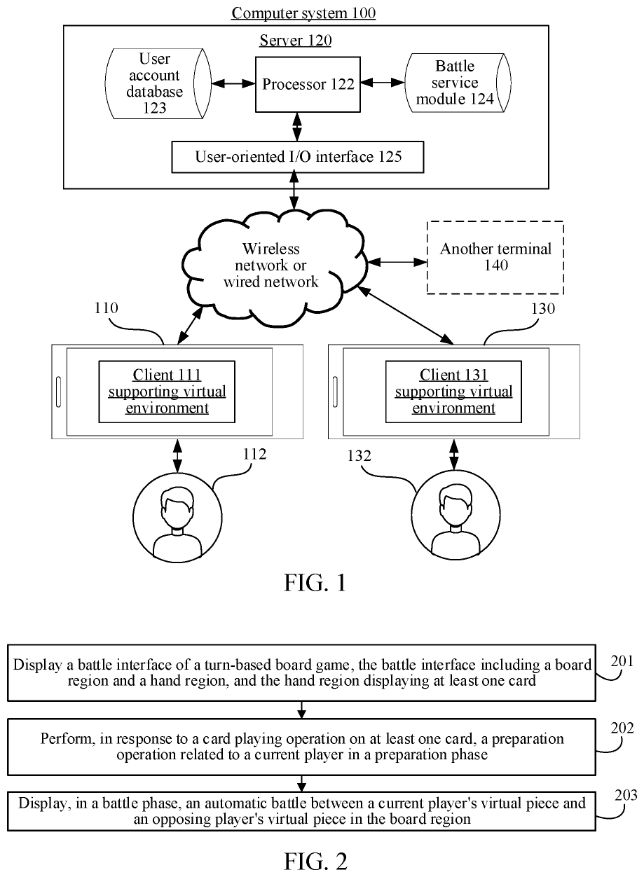

FIG. 1 is a structural block diagram of a computer system according to an exemplary embodiment of this application. A computer system 100 includes: a first terminal 110, a server 120, and a second terminal 130.

A client 111 supporting a virtual environment is installed and runs in the first terminal 110. The client 111 may be a round-based board game program. When the first terminal runs the client 111, a user interface (UI) of the client 111 is displayed on a screen of the first terminal 110. The client may be a client of an auto battler game. The first terminal 110 is a terminal used by a first user 112. The first user 112 lays out virtual pieces in a battle region of a board using the first terminal 110 in a preparation phase of a battle. The first terminal 110 or the server 120 automatically controls the virtual pieces to battle in the battle phase according to attributes, skills, and layout of the virtual pieces on the battle region.

A client 131 supporting a virtual environment is installed and runs in the second terminal 130. The client 131 may be a round-based board game program. When the second terminal 130 runs the client 131, a UI of the client 131 is displayed on a screen of the second terminal 130. The client may be a client of an auto battler game. The second terminal 130 is a terminal used by a second user 132. The second user 132 lays out virtual pieces in the battle region of the board using the second terminal 130 in the preparation phase of the battle. The second terminal 130 or the server 120 automatically controls the virtual pieces to battle in the battle phase according to attributes, skills, and layout of the virtual pieces on the battle region.

In some embodiments, the virtual pieces laid out by the first user through the first terminal 110 and the virtual pieces laid out by the second user through the second terminal 130 are located in different battle regions on a same board, that is, the first user and the second user are located in the same board of the same battle. Alternatively, the virtual pieces laid out by the first user through the first terminal 110 and the virtual pieces laid out by the second user through the second terminal 130 are located on different boards, that is, the first user and the second user are located in different boards of the same battle. In an exemplary embodiment, six user accounts participate in a battle of a round-based board game. Two of the six user accounts are matched in each turn, and the two matched user accounts battle on the same board in this turn.

In some embodiments, the clients installed on the first terminal 110 and the second terminal 130 are the same, or the clients installed on the two terminals are the same type of clients on different operating system platforms (Android or IOS). The first terminal 110 may refer to one of a plurality of terminals, and the second terminal 130 may refer to another one of the plurality of terminals. In this embodiment, only the first terminal 110 and the second terminal 130 are used as examples for description. A device type of the first terminal 110 may be the same as or different from a device type of the second terminal 130. The device type includes at least one of a smartphone, a tablet computer, an e-book reader, an MP3 player, an MP4 player, a laptop portable computer, and a desktop computer. In the following embodiments, an example in which a terminal includes a smartphone is used for description.

A person skilled in the art may understand that more or fewer terminals may be provided. For example, there may be only one terminal (that is, the user battles against artificial intelligence (AI)), or there may be six or eight or more terminals. The quantity of terminals and the type of the device are not limited in this embodiment of this application.

FIG. 1 only shows two terminals. However, in different embodiments, there may be a plurality of another terminals 140 that may access the server 120. In some embodiments, there are alternatively one or more terminals 140 that correspond to a developer. A development and editing platform for a client that supports a virtual environment is installed on the terminal 140. The developer may edit and update the client on the terminal 140, and transmit an updated client installation package to the server 120 through a wired or wireless network. The first terminal 110 and the second terminal 130 may download the client installation package from the server 120 to update the client.

The first terminal 110, the second terminal 130, and another terminal 140 are connected to the server 120 through the wireless or wired network.

The server 120 includes at least one of one server, a plurality of servers, a cloud computing platform, and a virtualization center. The server 120 is configured to provide a background service for a client (a client of a round-based board game/a client of an auto battler game) supporting a 3D virtual environment. In some embodiments, the server 120 undertakes primary computing work, and the terminal undertakes secondary computing work. Alternatively, the server 120 undertakes the secondary computing work, and the terminal undertakes the primary computing work. Alternatively, the server 120 and the terminal perform collaborative computing using a distributed computing architecture.

In a schematic example, the server 120 includes a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and the another terminal 140, such as avatars of the user accounts, nicknames of the user accounts, fighting capacity indexes of the user accounts, and service areas of the user accounts. The battle service module 124 is configured to provide a plurality of battle rooms for users to battle. The user-oriented I/O interface 125 is configured to establish communication with the first terminal 110 and/or the second terminal 130 through the wireless or wired network for data exchange.

This embodiment of this application provides a round-based board game (auto battler game) based on a card operation. Various complex operations such as shop purchase, shop upgrade, virtual piece preparation, virtual piece deployment, virtual piece upgrade, and virtual piece equipping involved in the conventional auto battler game are all simplified in a card playing procedure. A card playing procedure is simple and suitable for small-screen terminals such as a mobile phone or a tablet. In addition, a 3D model of a virtual piece can carry only limited text information, and a card face of the card may carry more information such as “label”, “value”, “attribute”, and “entry effect”, thereby improving the utilization efficiency of a display region where the card is located.

FIG. 2 is a flowchart of a battle interaction method for a round-based board game according to an exemplary embodiment of this application. This embodiment is described using an example in which the method is performed by a terminal. A client supporting a round-based board game runs in the terminal. The method includes the following operations.

201: Display a battle interface of a round-based board game, the battle interface including a board region and a hand region, and the hand region displaying at least one card.

The battle interface is an interface in which two player objects perform a round-based battle in the round-based board game. The player object may be understood as at least one concept of a user, an account, a player, a player character, and a virtual player character.

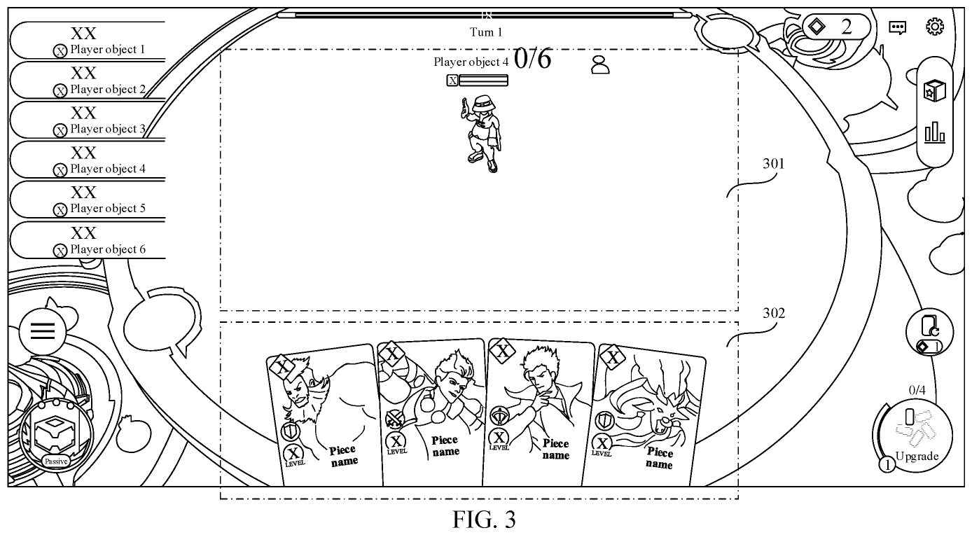

Referring to FIG. 3, the battle interface includes a board region 301 and a hand region 302.

The board region 301 is configured for accommodating at least one current player's virtual piece and at least one opposing player's virtual piece that participate in a battle, and is equivalent to a region occupied by a virtual board in the battle interface. The board region 301 includes a plurality of tiles arranged in an array, and these tiles are always displayed or are displayed only in some occasions. In some embodiments, the board region 301 is a two-dimensional board or a 3D board. This embodiment is described using an example in which the board region 301 is a 3D board viewed from a top view. The 3D board herein refers to the board being located in a 3D environment, rather than the board itself being certainly in a 3D form.

The hand region 302 is configured for displaying at least one card held by or dealt to a current player object. The at least one card is usually a plurality of cards. The at least one card includes at least one of a card automatically drawn or dealt by a background program to the current player object, a card obtained after some cards having a card draw effect are played, and a player character card acquired due to a player character skill. The quantity of cards has an upper limit, for example, a maximum of 8 cards, beyond which excess cards are automatically discarded.

In some embodiments, the plurality of cards are arranged in a sector shape in the hand region 302, and an arrangement sequence may be determined according to at least one factor of a drawing time, a card type, a quantity of cards of the same type, the quantity of identical cards, and a card rarity. In some embodiments, at least one card held by the current player object has an upper limit, for example, a maximum of 8 or 10 cards, beyond which excess cards are discarded. The current player object may play all or some cards in each turn of the battle. In some embodiments, in each turn of the battle, the current player object may further replace all or some cards. In some embodiments, different cards have different card types. Different card types have different preparation functions.

A match of the round-based board game includes a plurality of turns, and each turn includes a preparation phase and a battle phase.

202: Perform, in response to a card playing operation on at least one card, a preparation operation related to a current player in the preparation phase.

The card playing operation refers to an operation of playing one or more held cards. Exemplarily, the card playing operation is an operation of dragging a selected card toward the board region. Alternatively, the card playing operation includes a first clicking operation and a second clicking operation. The first clicking operation is an operation of clicking to select a card, and the second clicking operation is an operation of clicking a tile in the board region. A specific form of the card playing operation is not limited in this embodiment of this application. In some embodiments, a function of intelligently recommending playing cards may further be provided, which plays cards on behalf of the current player object in some turns. For example, the client intelligently recommends playing cards in first several turns for a new player.

At least one current player's virtual piece is a virtual piece participating in a battle in at least one turn (containing this turn). When the board region is a two-dimensional board, the virtual piece is also a two-dimensional virtual piece, and is displayed as a two-dimensional icon or a two-dimensional image. When the board region is a 3D board, the virtual piece is also a 3D piece, and is displayed as a 3D model or a 3D image. In an initial state, there may be no current player's virtual pieces located in the board region, and the current player object adds, deletes, or supplements virtual pieces in the board region. The current player's virtual piece that is not defeated in the previous turn may be automatically carried over to the next turn. In some embodiments, all current player's virtual pieces in the previous turn may be automatically carried over to the next turn.

A display state of a selected card is different from a display state of an unselected card. In some embodiments, the selected card has a prominently displaying effect, and the prominently displaying effect includes: bold frames, highlighted frames, dynamic frames, and moving the placement position in the card queue toward the board region by a preset distance.

The preparation operation includes at least one of adding a current player's virtual piece, reducing a current player's virtual piece, upgrading a current player's virtual piece, equipping equipment on a current player's virtual piece, removing equipment from a current player's virtual piece, and applying a buff effect to a current player's virtual piece.

Since different card types have different effects, the preparation operation is performed on at least one current player's virtual piece in the board region based on the card type of the selected card.

In the preparation phase, the current player object prepares at least one current player's virtual piece in the board region, and an opposing player object prepares at least one opposing player's virtual piece in the board region.

203: Display, in the battle phase, an automatic battle between the current player's virtual piece and the opposing player's virtual piece in the board region.

The automatic battle process of the current player's virtual piece and the opposing player's virtual piece in the board region does not need to be manually controlled by the current player object. The client or the server automatically controls, based on factors such as tile positions of the pieces on the board, virtual piece attributes, virtual piece levels, skills of the virtual pieces, and joint enhancement attributes between the virtual pieces, the virtual pieces to battle against each other until all pieces of one side are eliminated.

Both the current player object and the opposing player object have health points. After this turn ends, a part of value is deducted from the health point of the player object of the losing side. The part of value may be determined based on a quantity of remaining virtual pieces of the winning side, or may be a fixed value. This is not limited in this embodiment.

In summary, according to the method provided in this embodiment, a “card” mechanism is introduced in the round-based board game, multiple preparation operations are simplified and integrated in the process of playing a plurality of cards, and a shop concept is canceled. The player does not need to complete the acquisition, upgrading, and battling of the pieces based on multiple interactions between a plurality of sub-regions such as a shop, a piece preparation region, and a piece battle region on the conventional battle interface. The conventional piece purchasing process that requires active user selection is replaced with passively receiving dealt cards. A game system replaces some complex operations of the user, and the user can complete multiple preparation operations only using card-playing operations the same as those of a card game, thereby improving the human-computer interaction efficiency.

In particular, when the round-based board game is operated on a small-screen terminal such as a mobile phone or a tablet, the player may complete multiple preparation operations based on limited operations in the hand region, which can significantly improve the human-computer interaction efficiency compared with the conventional auto battler game.

### Division of Card Types of Virtual Cards

In some embodiments, the card types of the virtual cards include at least one of a piece card, an effect card, an equipment card, and a player character card.

### Piece Card

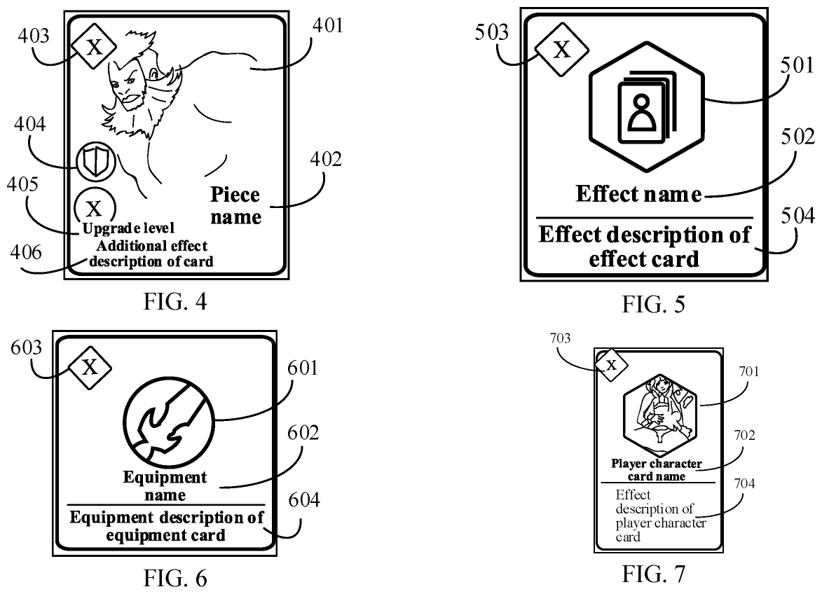

The piece card is a virtual card configured for summoning a current player's virtual piece or upgrading a piece level of the current player's virtual piece in the board region. FIG. 4 is a schematic card diagram of a piece card. The piece card displays at least one of the following pieces of information: a piece image 401, a piece name 402, an energy value 403 consumed when the card is played, a piece type or camp 404 to which the piece belongs, an increased level 405 of the piece after the card is played, and an additional effect description 406 of the piece.

The piece image 401 may be at least one of an avatar, an icon, a bust portrait, a full-body portrait, and a presentation animation of a virtual piece. In FIG. 4, an example in which the piece image 401 is the bust portrait of the virtual piece is used for description.

The piece name 402 is the name of the virtual piece. Using an example in which the virtual piece is a hero, the piece name is a hero name.

The energy value 403 refers to an energy value consumed when the piece card is played, and the energy value is an integer. Energy is a resource in the round-based board game. In some embodiments, cards of different rarities consume different amounts of energy during playing. For example, when cards of five different rarities are played, they consume 0, 1, 2, 3, and 4 energy points, respectively.

The piece type 404 is a classification attribute of a character played by the piece in the battle process. In an example, different virtual pieces may be classified into at least one piece type of a tank, a warrior, an assassin, a mage, a marksman, and a support. A camp is a classification attribute that pieces belong to a same piece group in the virtual world setting. In an example, different virtual pieces may be classified into at least one camp of the following: Great Wall, Three Kingdoms, Xuanyong, Mechanism, Yaotian, and Chang'an. For example, in the virtual world setting, two virtual pieces belonging to Great Wall guardians both belong to the Great Wall camp. In different embodiments, the piece type and the camp may be considered as a same classification attribute. In this embodiment, an example in which the piece type and the camp are different classification attributes is used.

The increased level 405 of the virtual piece after the card is played refers to an upgraded piece level for a same-name virtual piece (i.e., the same virtual piece) after the card is played when the virtual piece has existed in the board region. For example, the level 405 is a level 3, and a same-name virtual piece is originally a level 2, so that after the card is played, the same-name virtual piece is upgraded to a level 5. In some embodiments, different levels of same-name virtual pieces are increased after cards of different rarities are played. For example, after cards of five different rarities are played, levels of same-name virtual pieces are increased by 1, 2, 3, 4, and 5 levels, respectively.

The additional effect description 406 of the virtual piece is an effect description of an additional effect of the virtual piece. The additional effect may be triggered to take effect when playing a card, or may take effect when a particular trigger condition is satisfied in the battle process. For example, an exclusive skill of a virtual piece 1 is as follows. When the virtual piece 1 is present, each time another current player's virtual piece in the board region is sold, a current player's virtual piece of which the virtual piece type is “tank” is randomly selected, and a virtual piece level of the randomly selected current player's virtual piece is increased by a first value. The first value is a half level of the sold virtual piece.

### Effect Card

The effect card is a virtual card configured for applying an effect to at least one game factor in a game battle. The at least one game factor includes a virtual piece, a skill, virtual equipment, a buff effect, a level, a battle process, a virtual hand acquisition process, and the like. FIG. 5 is a schematic card diagram of an effect card. The effect card displays at least one of the following pieces of information: an effect icon 501, an effect name 502, an energy value 503 consumed when the card is played, and an effect description 504 of the effect card.

The effect icon 501 may be an icon configured for representing a buff effect of the effect card. FIG. 5 is described using an example in which the icon has a hexagonal outer frame. The effect name 502 is a name of the effect card or a name of the buff effect.

The energy value 503 refers to an energy value consumed when the effect card is played, and the energy value is an integer. Energy is a resource in the round-based board game. In some embodiments, cards of different rarities consume different amounts of energy during playing. For example, when cards of five different rarities are played, they consume 0, 1, 2, 3, and 4 energy points, respectively.

The effect description 504 of the effect card is configured for describing an effect of the effect card after being used. The effects of the effect card include, but are not limited to, at least one of the following:
1. increasing a probability and/or a quantity of piece cards acquired by the current player character;
2. increasing a probability or quantity of same-name piece cards that are associated with the virtual piece on the board and acquired by the current player character;
3. reducing the energy consumed when the current player character acquires a piece card;
4. increasing a quantity of piece cards replaced by the current player character;
5. reducing the energy consumed when the current player character replaces a piece card;
6. increasing a piece level of at least one virtual piece on the board;
7. equipping virtual equipment on at least one virtual piece on the board;
8. increasing an equipment level for at least one virtual piece on the board;
9. reducing energy consumption during card playing/card replacement;
10. increasing acquisition probabilities of some cards;
11. increasing an acquired quantity of some cards;
12. increasing a card replacement opportunity, and so on. Details are not described herein again.

For example, an effect of a “Two together” card is: randomly obtaining two same hero cards. An effect of a “Talent search” card is: selecting, based on the current player character level, a hero card of the highest rarity among three options. An effect of a “Copy” card is: randomly obtaining a card with the same name as that of a hero on the board. An effect of a “Bountiful harvest” card is: immediately supplementing the cards to 5. An effect of a “Random enhancement” card is: randomly selecting one hero on the board and increasing its level by five. An effect of a “One more time” card is: drawing one card and obtaining one additional free card replacement opportunity in this turn. An effect of a “Prayer” card is: reducing the energy value of all cards by one. An effect of an “Add cards” card is: drawing two cards.

In some embodiments, the effect card may be classified into at least one of a universal effect card, a piece type effect card, and a camp effect card. The universal effect card is an effect card whose card attribute is unrelated to the piece type/camp, and the card attribute includes at least one of an acquisition condition, a use condition, a card effect, and an effect range. The piece type effect card is an effect card whose card attribute is related to the piece type, for example, a card that can only be acquired, used, or have its effect enjoyed by a virtual piece of a specified piece type. The camp effect card is an effect card whose card attribute is related to a camp, for example, a card that can only be acquired, used, or have its effect enjoyed by a virtual piece of a specified camp.

For example, a piece type effect card may be acquired at a particular probability only when a piece card of the piece type is played.

### Equipment Card

The equipment card is a virtual card configured for equipping at least one current player's virtual piece. FIG. 6 is a schematic card diagram of an equipment card according to an exemplary embodiment of this application. The equipment card displays at least one of the following pieces of information: an equipment icon 601, an equipment name 602, an energy value 603 consumed when the card is played, and an equipment description 604 of the equipment card.

The equipment icon 601 may be an icon configured for representing an equipment image or an equipment effect. FIG. 6 is described using an example in which the icon has a circular outer frame. The equipment name 602 is a name of the equipment card or a name of the equipment. Different equipment may enhance a battle capability of a current player's virtual piece or weaken a battle capability of an opposing player's virtual piece in different dimensions such as blood volume, armor, defense, and magic point.

The energy value 603 refers to an energy value consumed when the equipment card is played, and the energy value is an integer. Energy is a resource in the round-based board game. In some embodiments, cards of different rarities consume different amounts of energy during playing. For example, when cards of five different rarities are played, they consume 0, 1, 2, 3, and 4 energy points, respectively. In some embodiments, energy values consumed by different cards may be periodically or aperiodically adjusted based on game balance.

The equipment description 604 of the equipment card is configured for describing an effect of the equipment after being equipped.

### Player Character Card

The player character card is a virtual card acquired through a player character skill of a virtual player character. The player character card may be a card triggered to be acquired by a passive skill or an active skill of a virtual player character, a card that can only be acquired by a particular virtual player character, a card that can only be used by a particular virtual player character, a card exclusive to a particular virtual player character, or the like. This is not limited in this embodiment of this application.

FIG. 7 is a schematic card diagram of a player character card according to an exemplary embodiment of this application. The player character card displays at least one of the following pieces of information: a card icon 701, a player character card name 702, an energy value 703 consumed when the card is played, and an effect description 704 of the player character card.

The card icon 701 may be an icon configured for representing a card effect. FIG. 7 is described using an example in which the icon has a hexagonal outer frame. The player character card name 702 is a name of the player character card or a name of an effect.

The energy value 703 refers to an energy value consumed when the player character card is played, and the energy value is an integer. Energy is a resource in the round-based board game. In some embodiments, cards of different rarities consume different amounts of energy during playing. For example, when cards of five different rarities are played, they consume 0, 1, 2, 3, and 4 energy points, respectively. In some embodiments, energy values consumed by different cards may be periodically or aperiodically adjusted based on game balance.

The effect description 704 of the player character card is configured for describing an additional effect after the player character card is used. The effect of the player character card may be the same as or similar to effects of the piece card, the equipment card, and the effect card, or may exceed effect scopes of the piece card, the equipment card, and the effect card. In designs of different embodiments, the effect of the player character card may be designed in any form, such as summoning a virtual piece, upgrading a virtual piece, adding equipment, applying a buff effect, reducing energy consumption, and affecting a hand acquisition procedure. The effect of the player character card may be designed to affect any process or detail in a game battle. This is not limited in this embodiment of this application.

Based on the introduction of the foregoing four types of cards, the following content may be learned.

Different types of cards have different functions. Through the piece card, the shop in the conventional auto battler game may be canceled based on the playing characteristics of the card. Through the effect card, an effect button or control in the conventional auto battler game may be canceled. Through the equipment card, a creep turn in the conventional auto battler game may be canceled. Through the player character card, the playing characteristics related to the player character may be integrated. Based on different types of cards, different mechanisms in the round-based board game are simplified to a card playing procedure, that is, UI elements that need to be displayed on a battle interface may be reduced, and the operation difficulty of the current player object may be further simplified, thereby improving the human-computer interaction efficiency of the current player object.

In addition, since text information that can be carried by the 3D virtual piece is limited, the 3D virtual piece cannot carry the text information well. However, compared with the 3D virtual piece, the two-dimensional card can naturally carry more text information and icon information due to its card characteristics. Thus, compared with the 3D virtual piece in the conventional preparation process, the two-dimensional card can further improve the amount of information carried in a limited display range on a small-screen terminal, thereby improving the information transmission efficiency.

The foregoing cards can be played not only in the preparation phase, but also some cards may be played in the battle phase. For example, for some equipment cards, effect cards of two more cards are drawn immediately.

### Acquisition Manner of Card

When an acquisition condition is satisfied, the current player object acquires at least one card. The acquisition condition includes at least one of the following.

Acquisition condition 1: Start a new turn of round-based battle. Each time a new turn of round-based battle is started, several cards are obtained. For example, four cards are drawn from a first turn of round-based battle, and two cards are drawn from a subsequent turn of round-based battle.

Acquisition condition 2: Use a preset piece card. The preset piece card refers to a piece card having additional skills such as drawing, adding, or copying a card. For example, an effect card is additionally acquired when a same-name piece card corresponding to a virtual piece on the board is played.

Acquisition condition 3: Use a preset effect card. The preset effect card refers to an effect card having an effect such as drawing, adding, or copying a card.

Acquisition condition 4: Use a preset player character card. The preset player character card refers to an effect card having an effect such as drawing, adding, or copying a card.

Acquisition condition 5: Consume current player's resources for replacement. For example, energy is consumed for drawing or replacement.

Acquisition condition 6: Upgrade a player character level of a virtual player character. After the player character level is upgraded, cards of higher rarities or a larger quantity of cards may be unlocked.

Acquisition condition 7: Upgrade a card pool level. After the card pool level is upgraded, cards of higher rarities or a larger quantity of cards may be unlocked.

Acquisition condition 8: Purchase a card.

Acquisition condition 9: Trigger a preset player character skill. The preset player character skill refers to a passive skill or an active skill having an effect such as drawing, adding, or copying a card. For example, one player character card may be drawn every two turns. One player character card may be drawn each time three cards are played.

The foregoing acquisition conditions may be combined. For example, some cards can only be acquired using a preset player character card after the player character level reaches level 2. Different types of cards may have completely different, completely identical, or partially identical and partially different acquisition conditions.

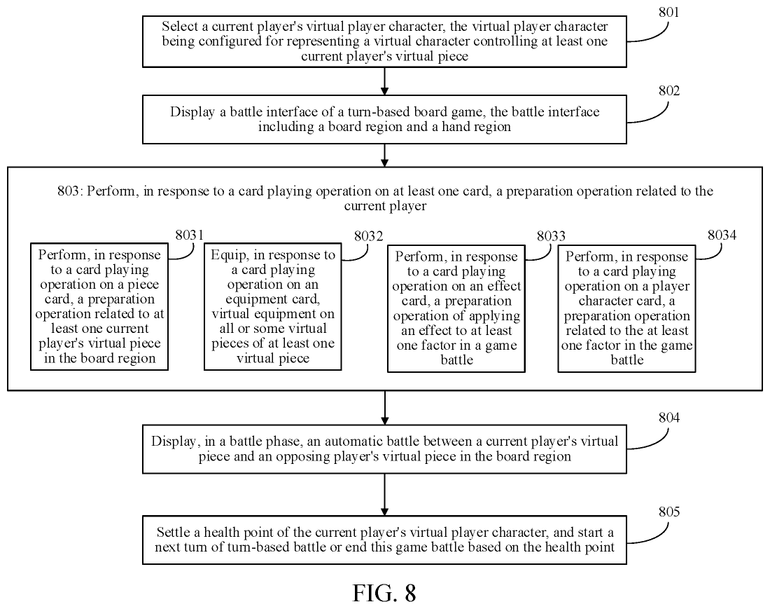

FIG. 8 is a flowchart of a battle interaction method for a round-based board game according to an exemplary embodiment of this application. This embodiment is described using an example in which the method is performed by a terminal. The method includes the following operations.

### Player Character Selection Phase

801: Select a current player's virtual player character, the virtual player character being configured for representing a virtual character controlling at least one current player's virtual piece.

Before starting a game battle each time, a current player character selects a desired virtual player character. Different virtual player characters have different player character skills. A player character skill is usually related to acquiring a player character card, or may be related to other game factors.

In some embodiments, for different player character skills, there are some respective passive trigger mechanisms to make the current player character obtain some cards with special effects. For example, a skill effect of a player character is that: each time three piece cards are played, a treasure player character card is obtained. An effect of the treasure player character card is that: 1 point of energy is consumed, and a level of a current player's virtual piece in the board region is specified to be increased by 2.

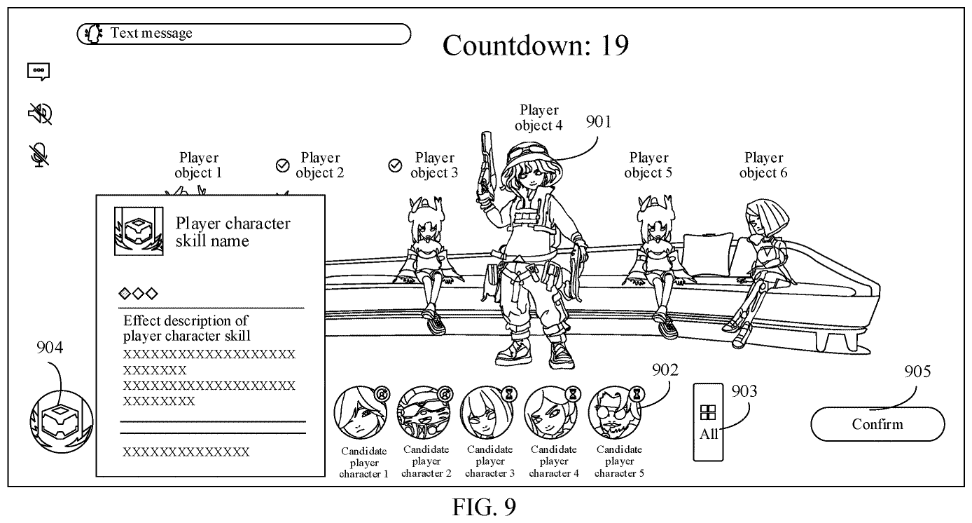

Exemplarily, as shown in FIG. 9, before a game battle is started, a player character selection interface is displayed. The player character selection interface displays virtual player characters selected by 6 player objects. In some embodiments, a virtual player character 901 selected by the current player object is prominently displayed. Using an example in which the current player object is a player object 4, a virtual player character selected by the player object 4 is prominently displayed through standing, being enlarged, and centered in the foreground, and virtual player characters selected by other player objects are displayed conventionally in a sitting posture, at a normal size, and arranged on two sides.

Several candidate virtual player characters 902, for example, candidate player characters 1 to 5, are displayed on the player character selection interface. Other candidate player characters may be viewed by swiping left and right, or all candidate player characters may be viewed by clicking an “All” button 903.

A player character skill button 904 is further displayed on the player character selection interface. In response to the player character skill button 904 being clicked, a player character skill name and effect description of a currently selected virtual player character may be viewed in a right pop-up window.

In some embodiments, a message transmitted by another player and a countdown for selecting a player or entering a battle are displayed at the top of the player character selection interface. A text message transmitting button, a speaker off/on button, and a microphone off/on button are displayed on the left side of the player character selection interface. After the virtual player character selected by the current player object is determined, a “Confirm” button 905 may be clicked to enter a preparation state.

n player objects participating in a turn of game battle perform round-based battles in pairs. Each turn includes a preparation phase and a battle phase.

### Preparation Phase of Each Turn

802: Display a battle interface of a round-based board game, the battle interface including a board region and a hand region.

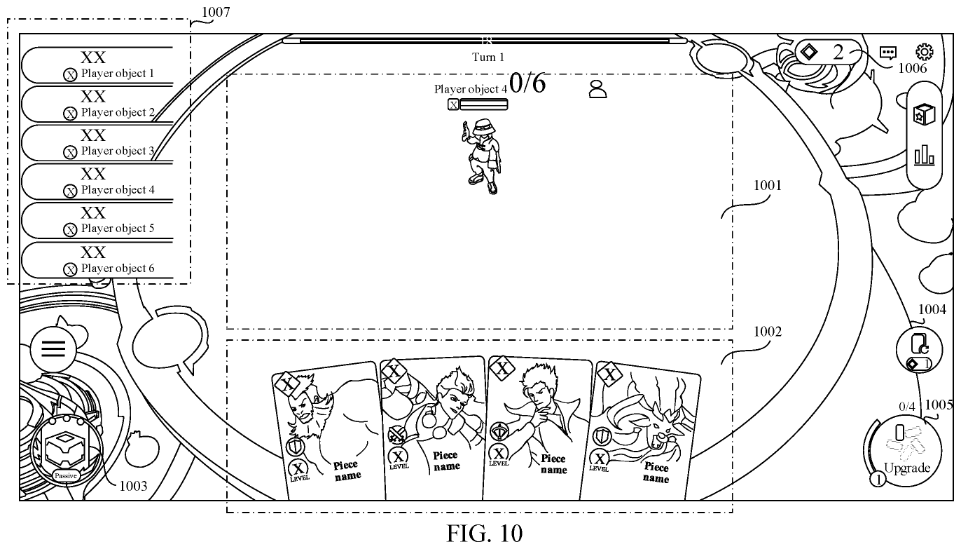

Referring to FIG. 10, the board region 1001 is configured for placing at least one current player's virtual piece and at least one opposing player's virtual piece. In some embodiments, an upper half of the board region 1001 is configured for placing at least one opposing player's virtual piece, and a lower half of the board region 1001 is configured for placing at least one current player's virtual piece. The hand region 1002 is configured for displaying at least one card held by a current player object. In an initial state or in some cases (for example, all cards in a current turn are played), a quantity of cards displayed in the hand region 1002 is 0.

In some embodiments, attribute information of n player objects participating in this game battle is further displayed at an upper left corner of the battle interface. The attribute information includes at least one of a nickname of a player, an avatar of a player, a blood volume of a player, and a player character level of a player. A player character skill button 1003 is displayed at a lower left corner of the battle interface. A card replacement button 1004 and an upgrade button 1005 are further displayed at a lower right corner of the battle interface. The card replacement button 1004 is configured for replacing one or more cards in the hand region 1002. The upgrade button 1005 is configured for upgrading a level of a virtual player character to unlock a higher-level card and capability and acquire equipment.

In some embodiments, an energy control 1006 is further displayed on the battle interface. The energy control 1006 is configured for displaying an energy value possessed by the current player object. Energy is a game resource that may be required throughout various phases of a game battle. For example, playing a card needs to consume energy, replacing a card needs to consume energy, and upgrading a player character level needs to consume energy.

In some embodiments, an identifier display region 1007 is further displayed on the battle interface. Identifiers of all players participating in the round-based board game are displayed in the identifier display region 1007. In the identifier display region 1007, identifiers of a plurality of players may be randomly arranged and displayed, or may be displayed in descending order of winning times of the plurality of players in the current round-based board game. This is not limited in this embodiment of this application.

In some embodiments, an order of the current turn is displayed on the top of the battle interface. Referring to FIG. 10, a preparation phase of a first turn of the round-based board game is currently shown.

803: Perform, in response to a card playing operation on at least one card, a preparation operation related to the current player.

The card type includes at least one of a piece card, an equipment card, an effect card, and a player character card. The current player's player object may perform preparation operations of different functions through a card playing operation on different piece cards. This operation includes at least one of the following operations.

8031: Perform, in response to a card playing operation on the piece card, a preparation operation related to at least one current player's virtual piece in the board region.

8032: Equip, in response to a card playing operation on the equipment card, virtual equipment on all or some virtual pieces of at least one virtual piece.

8033: Perform, in response to a card playing operation on the effect card, a preparation operation of applying an effect to at least one factor in a game battle.

8034: Perform, in response to a card playing operation on the player character card, a preparation operation related to the at least one factor in the game battle.

Since a battle situation differs in each turn of round-based battle, and each player object has a different hand and a different card playing habit, a quantity of times and a sequence of performing 8031, 8032, 8033, and 8034 in each turn of round-based battle may be changed. This is not limited in this embodiment.

For operation 8031 (piece card):

In some embodiments, the cards located in the hand region include a first virtual piece card. In response to a card playing operation on the first virtual piece card, a first current player's virtual piece is added to the board region. The first current player's virtual piece is a virtual piece corresponding to the first virtual piece card. In some embodiments, the first current player's virtual piece is a virtual piece not summoned to the board region.

That is, when the first current player's virtual piece does not exist in the board region, the first current player's virtual piece is added to the board region in response to the card playing operation on the first virtual piece card.

In response to the card playing operation on the first virtual piece card, at least two candidate tiles are displayed in the board region, and a first indication element corresponding to the first virtual piece card is displayed. The first indication element includes at least one of a zoomed-out first virtual piece card, a first current player's virtual piece, and a first indication arrow. In response to a dragging operation of dragging the first indication element to a first candidate tile, the first current player's virtual piece is added to the first candidate tile. The first candidate tile is one of the at least two candidate tiles.

The at least two candidate tiles may be all candidate tiles, or may be current player's candidate tiles. The at least two candidate tiles may always be displayed, or may be displayed only when a card playing operation is recognized.

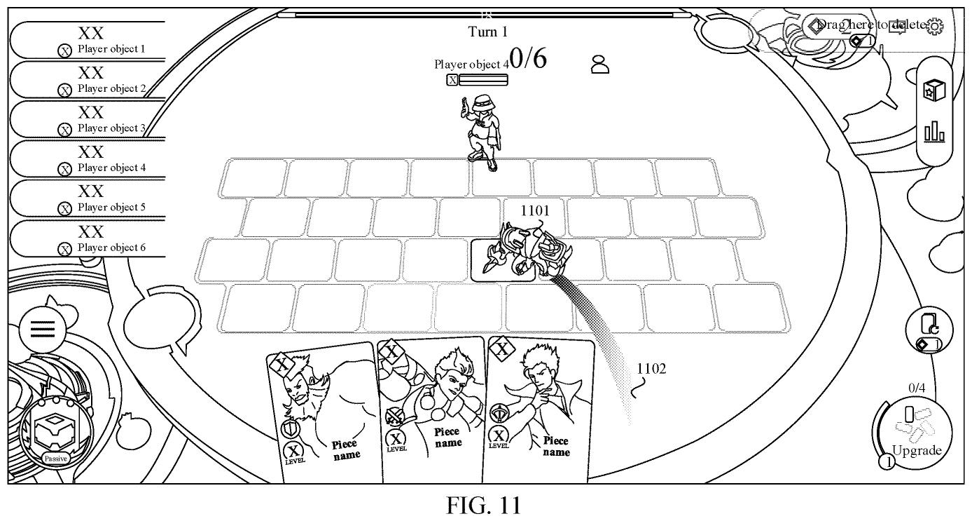

An example in which the first virtual piece card is the fourth card in FIG. 10 is used. Referring to FIG. 11, in response to a dragging operation on the first virtual piece card, a first current player's virtual piece 1101 and a first indication arrow 1102 are displayed. The first current player's virtual piece 1101 is a 3D piece, and slides following a real-time position of the dragging operation. A starting point of the first indication arrow 1102 is a position of the first virtual piece card before being played, and an end point is the real-time position of the dragging operation. When the release position of the dragging operation falls within the first candidate tile, the first current player's virtual piece 1101 is summoned to the first candidate tile.

It can be learned based on FIG. 11 that, the interaction manner eliminates a piece preparation region, and the hand region serves piece acquisition and preparation functions simultaneously, thereby realizing the sharing of a plurality of functions in one display region and improving the human-computer interaction efficiency.

In some embodiments, the cards located in the hand region include a second virtual piece card. In response to a card playing operation on the second virtual piece card and the existence of a second current player's virtual piece already in the board region, a piece level of the second current player's virtual piece is upgraded in the board region. The second current player's virtual piece is a virtual piece corresponding to the second virtual piece card.

The card playing operation on the second virtual piece card may alternatively be a dragging operation. However, since the second current player's virtual piece already exists in the board region, a release position of the dragging operation may be completed at any position in the board region, without the need for the current player object to precisely drag it onto the second current player's virtual piece.

For operation 8032 (equipment card):

In some embodiments, the cards located in the hand region include an equipment card. In response to a card playing operation on the equipment card, a second indication element corresponding to the equipment card is displayed. The second indication element includes at least one of a zoomed-out equipment card, virtual equipment corresponding to the equipment card, and a second indication arrow.

In response to a dragging operation of dragging the second indication element to the second current player's virtual piece, virtual equipment is equipped for the second current player's virtual piece.

The second current player's virtual piece is a current player's virtual piece already existing in the board region.

For operation 8033 (effect card):

In some embodiments, the cards located in the hand region include an effect card. In response to a card playing operation on the effect card, an effect is applied to at least one current player's virtual piece, and/or an effect is applied to an acquisition procedure of the card.

According to action objects, the effect cards include two major categories.
Type 1: Apply an effect to a current player's virtual piece in the board region.
Type 2: Apply an effect to an acquisition procedure of the card.

In response to a card playing operation on the effect card of type 1, an effect is applied to at least one current player's virtual piece. For example, a buff exclusive to the piece type and a joint buff when at least two pieces of the same camp are on the board are applied.

In response to a card playing operation on the effect card of type 2, an effect is applied to the acquisition procedure of the card. For example, two same piece cards are continuously drawn.

For operation 8034 (player character card):

In response to a card playing operation on the player character card, at least one of the following preparation operations is performed:
adding of a current player's virtual piece, reducing of a current player's virtual piece, upgrading of a current player's virtual piece, applying an effect to a current player's virtual piece, equipping a prop on a current player's virtual piece, an operation related to card acquisition, an operation related to card sale, an operation related to card replacement, an operation related to a subsequent turn, and an operation related to a health point of a current player object.

That is, a function of the player character card is special, may be any one of a piece card, an equipment card, and an effect card, may be a function related to the acquisition procedure of the card, or may be a function related to the health point of the player character. In different design implementations, a function that can affect a factor in a game battle may be designed as a function of a player character card. This is not limited in this embodiment of this application.

In the preparation phase, the current player object may further use at least one of a card replacement function, a card deletion function, or a player character level upgrade function.

### Card Replacement Function

In the preparation phase, the current player object may further replace one or more cards in the hand region. One or more cards are replaced by clicking a card replacement button. Card replacement needs to consume energy. For example, cards can be replaced only once in each turn, and a plurality of cards can be replaced at a time. No matter how many cards are replaced, 1 point of energy is consumed.

### Card Deletion Function

In a card playing process, a card may be deleted or sold by dragging the card to a specified position. Resources consumed by a deleted card cannot be recycled, a part of resources may be recycled, or fixed energy may be recycled. For example, each time a card is deleted, 1 point of energy may be obtained.

### Player Character Level Upgrade Function

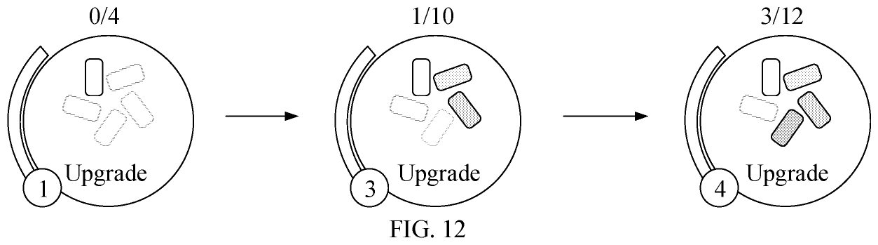

The current player object acquires several pieces of energy in each turn. Energy not used in this turn may be accumulated to a next turn, and the player character level may be upgraded using energy. A higher player character level indicates higher rarities of cards that may be extracted in each turn, and meanwhile, some new capabilities, such as talents and purchasable equipment, are unlocked. In some embodiments, rarity identifiers of different colors may be displayed on the upgrade button. As the player character level upgrades, a rarity identifier corresponding to a current player character level is illuminated to indicate a card rarity that can be acquired by the current player character level. The rarity identifier may be a small circular rectangle shown in FIG. 12, or may be of another shape or form.

For example, when the player character level of the current player object is 1/2/3/4/5, cards of rarities 1/2/3/4/5 are unlocked, respectively.

### Battle Phase of Each Turn

804: Display, in the battle phase, an automatic battle between the current player's virtual piece and the opposing player's virtual piece in the board region.

The automatic battle process of the current player's virtual piece and the opposing player's virtual piece in the board region does not need to be manually controlled by the current player object. The client or the server automatically controls, based on factors such as tile positions of the pieces on the board, virtual piece attributes, virtual piece levels, skills of the virtual pieces, and joint enhancement attributes between the virtual pieces, the pieces to battle against each other until all pieces of one side are eliminated.

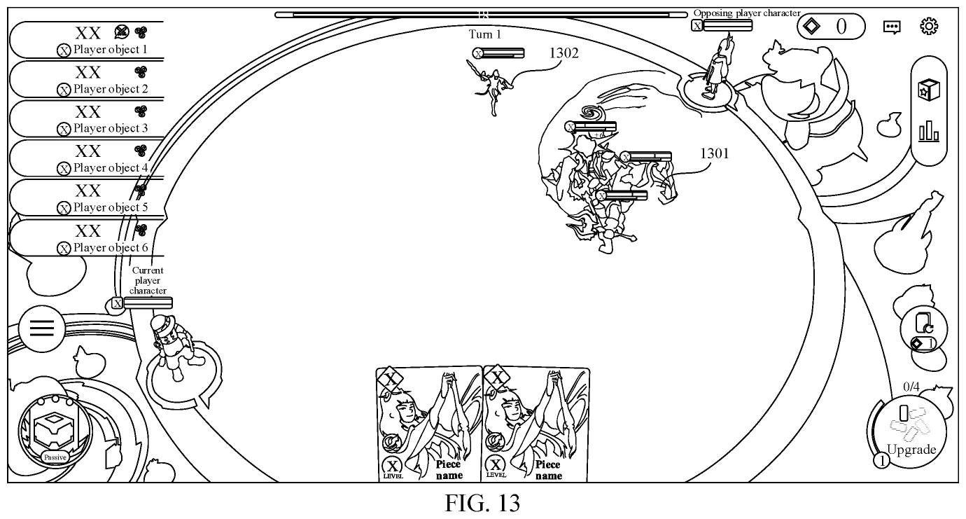

FIG. 13 is a schematic diagram of an automatic battle between a current player's virtual piece 1301 and an opposing player's virtual piece 1302 in a board region. None of the actions, such as movement, skill release, and function of the two virtual pieces during the battle, does not need to be manually controlled by the player.

### Battle Settlement Phase

805: Settle a health point of a current player's virtual player character, and start a next turn of round-based battle or end this game battle based on the health point.

Both the current player object and the opposing player object have health points. After this turn ends, a part of value is deducted from the health point of the player object of the losing side. The part of value may be determined based on a quantity of remaining virtual pieces of the winning side, or may be a fixed value. This is not limited in this embodiment.

When the health point is deducted to zero, the piece is eliminated from this turn of game battle.

When the health point is not deducted to zero, a next turn of round-based battle is started in this turn of game battle, and a battle is continued with one of n player objects until the player object is eliminated, or a last non-eliminated side obtains a victory of this turn of game battle.

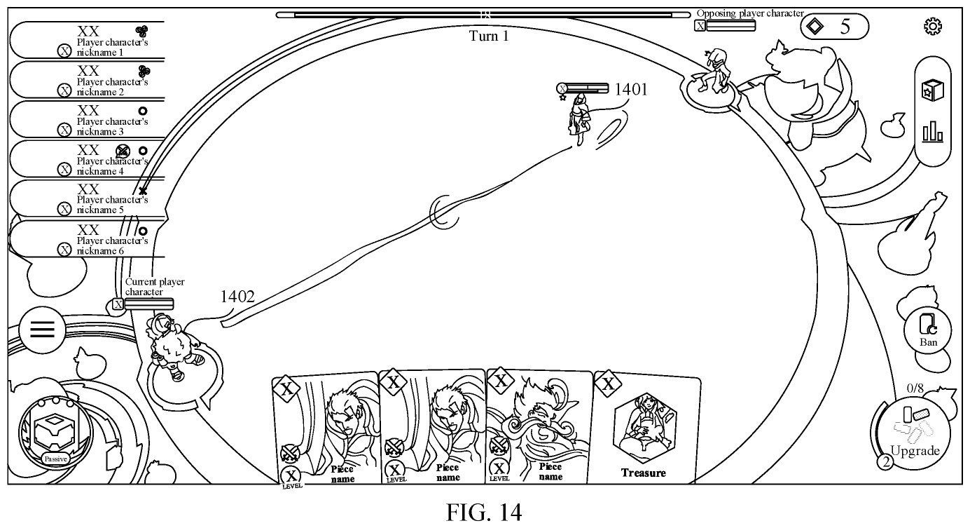

In some embodiments, the settlement damage is determined according to a quantity of virtual pieces of the winning side remaining on the board. FIG. 14 shows an animation special effect for settling a health point of a current player's virtual player character 1402 when the current player is a losing side and there is one remaining opposing player's virtual piece 1401. A health point progress bar may be displayed at the head of the virtual player character 1402.

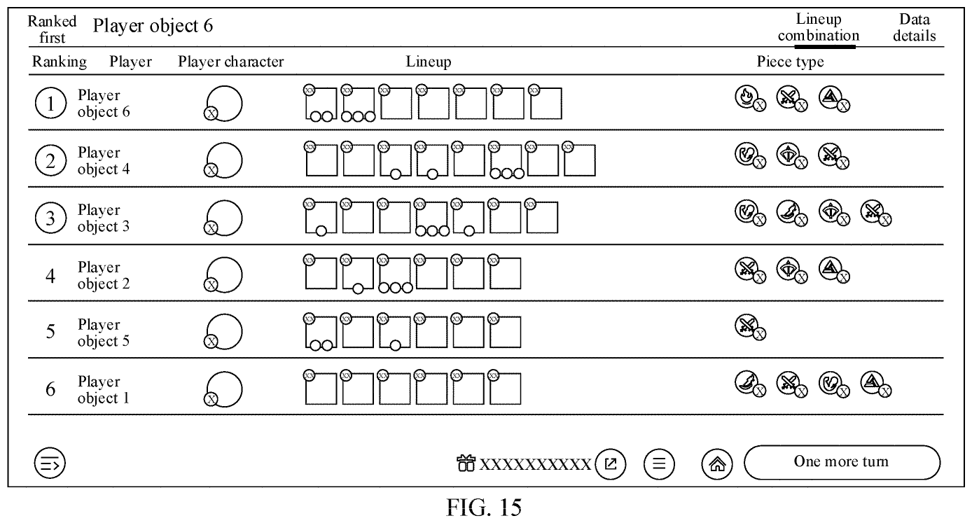

Exemplarily, referring to FIG. 15, the settlement interface displays settlement information of this game battle. The settlement information includes information such as rankings of players, player characters, a lineup, and piece types used by each player.

In summary, according to the method provided in this embodiment, a “card” mechanism is introduced in the round-based board game, multiple preparation operations are simplified and integrated in the process of playing a plurality of cards, and a shop concept is canceled. The player does not need to complete the acquisition, upgrading, and battling of the virtual pieces based on multiple interactions between a plurality of sub-regions such as a shop, a piece preparation region, and a piece battle region on the conventional battle interface. The conventional virtual piece purchasing process that requires active user selection is replaced with passively receiving dealt cards. A game system replaces some complex operations of the user, and the user can complete multiple preparation operations only using card-playing operations the same as those of a card game, thereby improving the human-computer interaction efficiency.

In particular, when the round-based board game is operated on a small-screen terminal such as a mobile phone or a tablet, the player may complete multiple preparation operations based on limited operations in the hand region, which can significantly improve the human-computer interaction efficiency compared with the conventional auto battler game.

According to the method provided in this embodiment, through the piece card, the shop in the conventional auto battler game may be canceled based on the playing characteristics of the card, and the complex process in which a user originally needs to purchase a desired virtual piece from dozens of sellable virtual pieces in the shop is changed to a process in which a game system automatically deals several cards to a player. The user does not need to manually select a card, thereby reducing a quantity of interaction operations required when the user acquires virtual pieces and an amount of information that the user needs to process.

According to the method provided in this embodiment, through the effect card, an effect button or control in the conventional auto battler game may be canceled. Through the equipment card, a creep turn in the conventional auto battler game may be canceled. Through the player character card, the playing characteristics related to the player character may be integrated. Based on different types of cards, different mechanisms in the round-based board game are simplified to a card playing procedure, that is, UI elements that need to be displayed on the battle interface may be reduced, time of actively searching for related function entries by the user is reduced, and the operation difficulty of the current player object may be further simplified, thereby improving the human-computer interaction efficiency of the current player object.

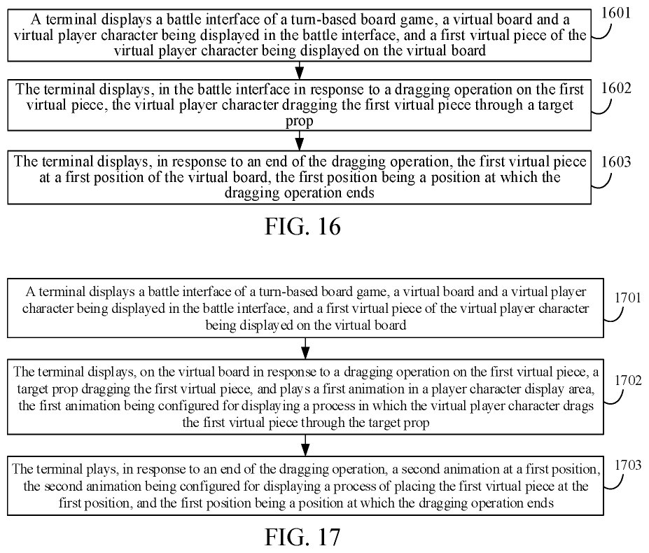

FIG. 16 is a flowchart of a battle interface display method according to an embodiment of this application. Using the method performed by a terminal as an example, as shown in FIG. 16, the method includes the following operations.

1601: A terminal displays a battle interface of a round-based board game, a virtual board and a virtual player character being displayed in the battle interface, and a first virtual piece of the virtual player character being displayed on the virtual board.

In this embodiment of this application, in the battle interface of the round-based board game, each player can place a virtual piece on the virtual board through a controlled virtual player character to battle with a virtual piece placed on the virtual board by another virtual player character, and can further adjust, through the controlled virtual player character, a position of the virtual piece of the virtual player character on the virtual board to change a layout of the virtual piece of the virtual player character on the virtual board, so that in a subsequent battle, the virtual piece of the virtual player character can battle with the virtual piece of another virtual player character according to the adjusted layout.

1602: The terminal displays, in the battle interface in response to a dragging operation on the first virtual piece, the virtual player character dragging the first virtual piece through a target prop. In some embodiments, in response to a dragging operation on the first virtual piece, the terminal renders a first animation in which the virtual player character drags the first virtual piece through a target prop in the player character display area simultaneously in parallel to the target prop dragging the first virtual piece on the virtual board.

In this embodiment of this application, the dragging operation on the first virtual piece is configured for dragging the virtual piece to change the position of the virtual piece on the virtual board. When the dragging operation on the first virtual piece is triggered, the virtual player character dragging the first virtual piece through the target prop is displayed in the battle interface, so that the first virtual piece moves on the virtual board along with the dragging operation to reflect the solution in which the virtual player character adjusts the layout of the virtual piece on the virtual board through the target prop, thereby improving a sense of participation of the virtual player character.

The target prop is a virtual prop of any type and is configured for dragging the virtual piece on the virtual board. In some embodiments, the target prop is an exclusive prop of the virtual player character, and different virtual player characters have different exclusive props. For example, the target prop is an exclusive virtual weapon of the virtual player character, and the virtual player character can drag the virtual piece on the virtual board through the exclusive virtual weapon possessed by the virtual player character. In some embodiments, the target prop is a virtual prop configured for dragging the virtual piece, and different virtual player characters may have a same target prop. For example, the target prop is a virtual fishing rod, and the virtual player character can drag the virtual piece on the virtual board through the virtual fishing rod. The dragging operation can be any type of dragging operation. For example, the dragging operation includes a pressing operation and a moving operation. The pressing operation refers to pressing the position of the first virtual piece on the virtual board, and the moving operation refers to an operation of moving while keeping the pressing operation. For example, the dragging operation on the first virtual piece refers to the player pressing a display position of the first virtual piece in the battle interface with a finger and keeping pressing to move a position of the finger in the battle interface.

In this embodiment of this application, a manner in which the virtual player character drags the first virtual piece through the target prop is as follows. The virtual player character can hold one end of the target prop, with the other end of the target prop acting on the first virtual piece, and the virtual player character can move the held target prop so that the target prop drags the first virtual piece. Alternatively, one end of the target prop acts on the first virtual piece, and the virtual player character can remotely control the target prop to move, so that the target prop drags the first virtual piece.

1603: The terminal displays, in response to an end of the dragging operation, the first virtual piece at a first position of the virtual board, the first position being a position at which the dragging operation ends.

In this embodiment of this application, in the process of triggering the dragging operation on the first virtual piece, the position of the first virtual piece changing along with the dragging operation may be displayed in the battle interface. When the dragging operation ends, the position at which the dragging operation ends is the adjusted position of the first virtual piece, and the first virtual piece is placed at the position at which the dragging operation ends, thereby adjusting the position of the first virtual piece on the virtual board.

The end of the dragging operation refers to the first virtual piece no longer being dragged, and the position at which the dragging operation ends is the position at which the user wants to place the first virtual piece. For example, the dragging operation is an operation of pressing and moving the first virtual piece, and the end of the dragging operation refers to the first virtual piece no longer being pressed.

In the solutions provided in the embodiments of this application, in response to the dragging operation on the virtual piece on the virtual board, a picture in which the virtual player character drags the virtual piece through a prop can be displayed, so as to reflect the solution in which the virtual player character adjusts the virtual piece layout in the virtual board through the target prop. Movement of the virtual pieces can precisely follow operations of the player, thereby reducing stuttering and delay, providing the player with an exceptionally smooth operational experience, and significantly improving the efficiency of controlling the virtual piece by the player. In addition, the sense of participation of the virtual player character in the process of adjusting the virtual piece layout is enhanced, so that the player can adjust the position of the virtual piece on the virtual board by acting as the virtual player character, thereby improving the interaction effect between the virtual player character and the player, enhancing the sense of immersion of the player, and further improving the player experience.

Based on the embodiment shown in FIG. 16, in this embodiment of this application, an effect that the virtual player character drags the virtual piece through the target prop can further be displayed at a plurality of positions in the battle interface, and when the dragging operation ends, a placement effect of the virtual piece can be displayed by playing an animation. Details of a specific process may refer to the following embodiment.

FIG. 17 is a flowchart of a battle interface display method according to an embodiment of this application. Using the method performed by a terminal as an example, as shown in FIG. 17, the method includes the following operations.

1701: A terminal displays a battle interface of a round-based board game, a virtual board and a virtual player character being displayed in the battle interface, and a first virtual piece of the virtual player character being displayed on the virtual board.

In an implementation, operation 1701 includes: displaying the battle interface in a preparation phase of any turn.

In this embodiment of this application, a match of the round-based board game includes a plurality of turns, and each turn includes a preparation phase and a battle phase. In the preparation phase, the virtual player character can use a virtual card to place a virtual piece on the virtual board and can further adjust the position of the virtual piece on the virtual board. In addition, in the preparation phase, only a virtual piece of a locally controlled virtual player character is displayed on the virtual board. After the preparation phase ends, the battle phase begins. In the battle phase, the virtual piece of the locally controlled virtual player character can be displayed on the virtual board to automatically interact with virtual pieces of other virtual player characters.

In some embodiments, in the preparation phase, the virtual player character is located in the virtual board. In response to entering the battle stage, the virtual player character is displayed in the battle interface as leaving the virtual board and standing outside the virtual board.

In this embodiment of this application, in the preparation phase, the virtual player character is located in the virtual board, so that it can be displayed subsequently that the virtual player character can adjust the virtual piece layout through the target prop. When the battle stage is entered, the virtual player character leaves the virtual board, so that the virtual piece of the virtual player character interacting with the virtual pieces of other virtual player characters can be displayed subsequently in the virtual board.

In an implementation, the battle interface includes a hand region, and a virtual card possessed by the virtual player character is displayed in the hand region.

In an implementation, the battle interface further includes an identifier display region. A plurality of player character identifiers are further displayed in the identifier display region, and indicate a plurality of virtual player characters participating in the same game battle.

The player character identifier can be represented in any form. For example, the player character identifier is represented by at least one of a player nickname, a player avatar, a player blood volume, and a player character level of a player.

1702: The terminal displays, on the virtual board in response to the dragging operation on the first virtual piece, the target prop dragging the first virtual piece, and plays a first animation in the player character display area, the first animation being configured for displaying a process in which the virtual player character drags the first virtual piece through the target prop.

In this embodiment of this application, the battle interface includes a player character display area, the player character display area is located outside the virtual board, and the virtual player character is displayed in the player character display area. The terminal detects the dragging operation on the first virtual piece. Not only a picture of dragging the first virtual piece by the target prop is displayed on the virtual board, but also an animation can be played in a region where the virtual player character is located, to reflect that the virtual player character drags the first virtual piece through the target prop, so as to enhance a picture display effect of the virtual player character dragging the virtual piece through the target prop. Thus, the player can more easily perceive the process of adjusting the position of the virtual piece through the target prop, thereby improving the interaction effect between the virtual player character and the player, enhancing the sense of immersion of the player, and further improving the player experience.

For example, a finger of the user presses the first virtual piece displayed on the terminal and starts to drag the first virtual piece, which is equivalent to triggering the dragging operation on the first virtual piece. The terminal displays, on the virtual board, the target prop dragging the first virtual piece to move with a pressing position of the finger, and plays the first animation in the player character display area, to present a picture in which the virtual player character drags the first virtual piece in the player character display area through the target prop.

In an implementation, operation 1702 includes: displaying, on the virtual board in response to the dragging operation on the first virtual piece, one end of the target prop acting on the first virtual piece to drag the first virtual piece, and playing the first animation in the player character display area, the first animation being configured for displaying that one end of the target prop acts on the first virtual piece, and the virtual player character holds the other end of the target prop to drag the first virtual piece through the target prop; and an orientation of the target prop in the first animation being synchronous with an orientation of the target prop on the virtual board.

In this embodiment of this application, one end of the target prop acting on the first virtual piece is displayed on the virtual board to reflect that the target prop is connected to the first virtual piece, and the first virtual piece can be dragged through the target prop. The virtual player character holding the other end of the virtual prop is displayed in the first animation. The first virtual piece is dragged through the target prop, and the orientation of the target prop in the first animation is synchronous with the orientation of the target prop on the virtual board, reflecting that the process of dragging the first virtual piece through the target prop in the first animation is a same process as the process of displaying the target prop dragging the first virtual piece in the virtual board, thereby enhancing a picture display effect, improving the interaction effect between the virtual player character and the player, enhancing the sense of immersion of the player, and further improving the player experience.

In some embodiments, the first virtual piece in the first animation is a zoomed-out model of the first virtual piece.

In this embodiment of this application, the virtual player character dragging the zoomed-out model of the first virtual piece through the target prop is displayed in the first animation, to reflect a display effect of the virtual player character dragging the first virtual piece through the target prop.

In an implementation, the method further includes: displaying, in the process in which the virtual player character drags the first virtual piece through the target prop, a floating effect around the first virtual piece, the floating effect indicating that the first virtual piece floats above the virtual board.

The floating effect can be represented in any form. For example, the floating effect is represented in a form where a virtual piece is zoomed out and floats above a virtual board, or in a form where a glowing effect is displayed around the virtual piece.

In this embodiment of this application, in the process of dragging the virtual piece, a floating effect is displayed around the virtual piece to indicate that the virtual piece floats above the virtual board, which can reflect that the virtual piece is being dragged, thereby improving the display effect when the virtual piece is dragged.

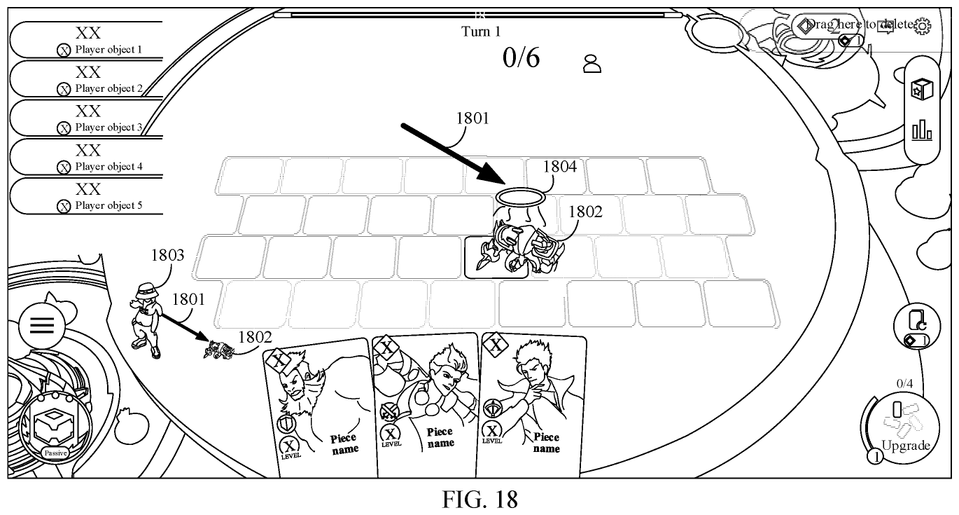

As shown in FIG. 18, the target prop is a virtual spear 1801 of the virtual player character. One end of the virtual spear 1801 acts on a first virtual piece 1802, and a virtual player character 1803 holds the other end of the virtual spear 1801. The virtual spear 1801 dragging the first virtual piece 1802 is displayed in the virtual board, and a floating effect 1804 is displayed around the first virtual piece 1802. An animation in which the virtual spear drags the first virtual piece is displayed in the player character display area. An orientation of the virtual spear in the animation is synchronous with an orientation of the virtual spear in the virtual board. The first virtual piece 1802 in the animation is a zoom-out model of the first virtual piece 1802 in the virtual board.

This embodiment of this application is described using an example in which the process of dragging the first virtual piece by the target prop is displayed in both the virtual board and the player character display area. However, in another embodiment, operation 1702 does not need to be performed, but another manner is used. That is, in response to the dragging operation on the first virtual piece, the virtual player character dragging the first virtual piece through the target prop is displayed in the battle interface.

1703: The terminal plays, in response to the end of the dragging operation, a second animation at the first position, the second animation being configured for displaying a process of placing the first virtual piece at the first position, and the first position being a position at which the dragging operation ends.

In this embodiment of this application, in response to the end of the dragging operation on the first virtual piece, the second animation is played at the position at which the dragging operation ends, to display the first virtual piece being placed at the position at which the dragging operation ends, thereby enhancing the performance of the virtual piece being placed at an adjusted position. Thus, the user can learn the adjusted position of the first virtual piece, thereby improving the player experience.

In an implementation, the second animation is configured for displaying a process in which the first virtual piece floating above the virtual board falls at the first position of the virtual board.

In an implementation, the second animation includes a placement animation played on the first virtual piece and a process in which the first virtual piece is placed at the first position.

In some embodiments, a process of acquiring the placement animation includes the following operations. The terminal transmits, in response to the end of the dragging operation, an animation acquisition request to the server, the animation acquisition request carrying a player character identifier of a virtual player character. The server queries, in response to the animation acquisition request, an animation corresponding to the player character identifier to obtain the placement animation, and transmits the placement animation to the terminal. The terminal receives the placement animation transmitted by the server, displays the first virtual piece being placed at the first position, and plays the placement animation on the first virtual piece.

The player character identifier is a unique identifier configured for representing a virtual player character, and can be represented in any form. For example, the player character identifier is represented using a name or a number of the virtual player character.

In this embodiment of this application, the server stores placement animations of dragging virtual pieces by virtual player characters, and the placement animations of dragging the virtual pieces by the virtual player characters are correspondingly stored with player character identifiers of the virtual player characters. When dragging any virtual piece by the virtual player character, the terminal can interact with the server to acquire the placement animation of dragging the virtual piece by the virtual player character, and then play the placement animation on the virtual piece, so as to reflect that when the dragging ends, the virtual piece is placed at the position at which the dragging operation ends.

In some embodiments, the server stores animations of dragging virtual pieces by virtual player characters of various player character types, and further stores correspondences between the player character identifiers and the player character types. In this case, the server queries, in response to the animation acquisition request, the correspondences to obtain a player character type to which the player character identifier belongs, and queries an animation corresponding to the player character type to obtain the placement animation.

In this embodiment of this application, the server stores object relationships between the player character identifiers and the player character types, and further stores animations corresponding to the player character types. After receiving the animation acquisition request, the server first queries the object relationship based on the player character identifier in the animation acquisition request to determine a player character type to which the player character identifier belongs, and further obtains, according to the determined player character type, an animation corresponding to the determined player character type from the stored animations to obtain the placement animation.

In this embodiment of this application, the placement process of the first virtual piece is displayed by playing an animation. However, in another embodiment, operation 1703 does not need to be performed, but another manner is used. That is, in response to the end of the dragging operation, the first virtual piece being placed at the first position is displayed, where the first position is a position at which the dragging operation ends.

In the solutions provided in the embodiments of this application, in response to the dragging operation on the virtual piece on the virtual board, a picture in which the virtual player character drags the virtual piece through a prop can be displayed, so as to reflect the solution in which the virtual player character adjusts the virtual piece layout in the virtual board through the target prop. Movement of the virtual pieces can precisely follow operations of the player, thereby reducing stuttering and delay, providing the player with an exceptionally smooth operational experience, and significantly improving the efficiency of controlling the virtual piece by the player. In addition, the sense of participation of the virtual player character in the process of adjusting the virtual piece layout is enhanced, so that the player can adjust the position of the virtual piece on the virtual board by acting as the virtual player character, thereby improving the interaction effect between the virtual player character and the player, enhancing the sense of immersion of the player, and further improving the player experience.

Based on the embodiment shown in FIG. 16, in this embodiment of this application, a virtual piece can be dragged only when the virtual piece satisfies a dragging condition, and when another virtual piece exists at the position at which the dragging operation ends, position exchange of the virtual pieces is displayed. Details of a specific process may refer to the following embodiment.

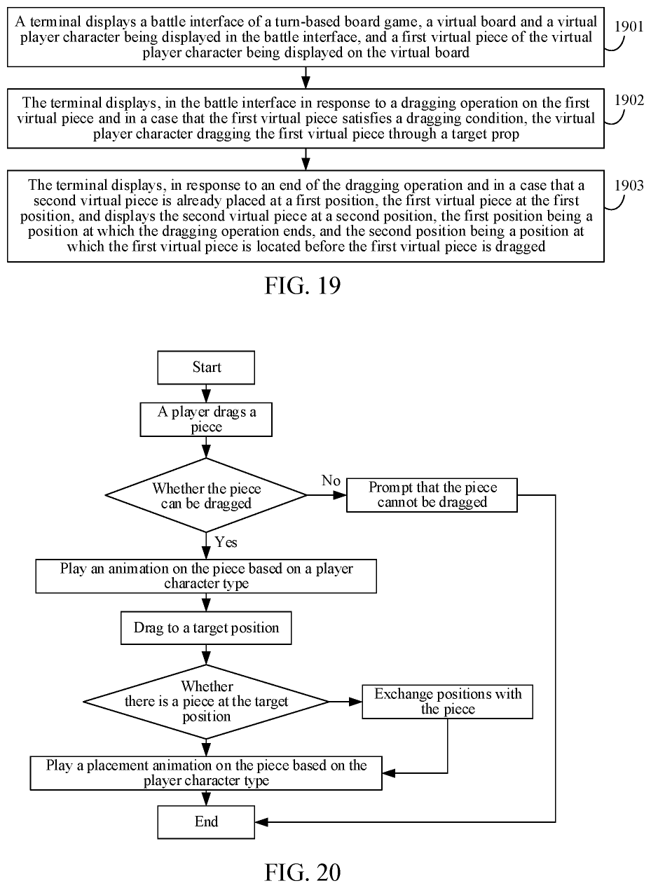

FIG. 19 is a flowchart of a battle interface display method according to an embodiment of this application. Using the method performed by a terminal as an example, as shown in FIG. 19, the method includes the following operations.

1901: A terminal displays a battle interface of a round-based board game, a virtual board and a virtual player character being displayed in the battle interface, and a first virtual piece of the virtual player character being displayed on the virtual board.

This operation is similar to operation 1701, and details are not described herein again.

1902: The terminal displays, in the battle interface in response to the dragging operation on the first virtual piece and when the first virtual piece satisfies a dragging condition, the virtual player character dragging the first virtual piece through the target prop.

In this embodiment of this application, not all virtual pieces on the virtual board can be dragged, but only a virtual piece that satisfies the dragging condition can be dragged. Therefore, when the first virtual piece satisfies the dragging condition, in response to the dragging operation on the first virtual piece, a process in which the virtual player character drags the first virtual piece through the target prop is displayed to enrich the gameplay. Restrictions are added to the dragging of the virtual piece to affect the virtual piece layout, preventing the virtual piece from being dragged indefinitely, which may affect the game balance, thereby improving the fairness of the game.

In an implementation, the dragging condition refers to the first virtual piece being a virtual piece converted from a virtual card in a previous turn, the first virtual piece having a movement skill, or the first virtual piece being a virtual piece converted from a virtual card in a current turn.

In this embodiment of this application, a virtual card can be used in a preparation phase of each turn of a same game battle, so that the virtual card is converted into a virtual piece on the virtual board and placed on the virtual board. In addition, the position of the virtual piece that has been placed on the virtual board can be adjusted in the preparation phase of each turn. In a current preparation phase, when the first virtual piece is placed in a preparation phase of the previous turn, the first virtual piece can be dragged to adjust the position of the first virtual piece on the virtual board.

In this embodiment of this application, the virtual piece on the virtual board may have a movement skill, and the movement skill can adjust the position of the virtual piece on the virtual board. When the first virtual piece has the movement skill, the first virtual piece can be dragged to adjust the position of the first virtual piece on the virtual board.

In this embodiment of this application, in the current preparation phase, the virtual card is converted into the first virtual piece on the virtual board using the virtual card, and then the first virtual piece can be dragged to adjust the position of the first virtual piece on the virtual board. In this way, operations of the user are facilitated, a case in which the user cannot operate after converting the virtual card into the virtual piece is avoided, and the user experience is improved.

In an implementation, the terminal plays, in the battle interface in response to the dragging operation on the first virtual piece, a third animation on the first virtual piece. The third animation is configured for displaying a process in which the virtual player character drags the first virtual piece through the target prop.

In this embodiment of this application, the third animation is configured for reflecting a process of dragging the first virtual piece through the target prop. The third animation is played on the first virtual piece to reflect that the virtual player character is dragging the first virtual piece through the target prop.

In some embodiments, a process of acquiring the third animation includes the following operations. The terminal transmits, in response to the dragging operation on the first virtual piece, an animation acquisition request to the server, the animation acquisition request carrying a player character identifier of a virtual player character. The server queries, in response to the animation acquisition request, an animation corresponding to the player character identifier to obtain the third animation, and transmits the third animation to the terminal. The terminal receives the third animation transmitted by the server, and plays the third animation on the first virtual piece.

In this embodiment of this application, the server stores animations of dragging virtual pieces by virtual player characters. When dragging any virtual piece by the virtual player character, the terminal can interact with the server to acquire the animation of dragging the virtual piece by the virtual player character, and then play the animation on the virtual piece to reflect the process of dragging the virtual piece by the virtual player character.

In some embodiments, the server stores animations of dragging virtual pieces by virtual player characters of various player character types, and further stores correspondences between the player character identifiers and the player character types. In this case, the server queries, in response to the animation acquisition request, the correspondences to obtain a player character type to which the player character identifier belongs, and queries an animation corresponding to the player character type to obtain the third animation.

The process of acquiring the third animation is the same as the foregoing process of acquiring the placement animation, and details are not described herein again.

In some embodiments, the animation acquisition request further carries a piece identifier of the first virtual piece. The server may further query a floating effect corresponding to the piece identifier and transmit the floating effect to the terminal. The terminal displays the floating effect on the first virtual piece.

In this embodiment of this application, the server stores the floating effect of each virtual piece by correspondingly storing the piece identifier and the floating effect. The terminal interacts with the server to acquire the floating effect when the virtual piece is dragged, so as to display the floating effect on the dragged virtual piece, thereby improving the display effect of the virtual piece.

In this embodiment of this application, the dragging operation on the first virtual piece can be triggered only when the first virtual piece satisfies the dragging condition. However, in another embodiment, operation 1902 does not need to be performed, but another manner is used. That is, in response to the dragging operation on the first virtual piece, the virtual player character dragging the first virtual piece through the target prop is displayed in the battle interface.

1903: The terminal displays, in response to the end of the dragging operation and when a second virtual piece is already placed at the first position, the first virtual piece at the first position, and displays the second virtual piece at a second position, the first position being a position at which the dragging operation ends, and the second position being a position at which the first virtual piece is located before the first virtual piece is dragged.

In this embodiment of this application, the first position is a position at which the first virtual piece is expected to be placed in the current dragging process of the first virtual piece. However, when there is the second virtual piece at the first position, it can be displayed that the first virtual piece is placed at the first position, and there is another piece placed at a position at which the first virtual piece is placed before the first virtual piece is dragged at the first position, so that the positions of the first virtual piece and the second virtual piece on the virtual board are exchanged, multiple possibilities of adjusting the virtual pieces on the virtual board are enriched, and the gameplay is enriched, providing multiple possibilities for layout of the virtual pieces on the virtual board. In addition, a procedure of adjusting the position of the virtual piece on the virtual board can be simplified, thereby improving the human-computer interaction efficiency.

For example, before the first virtual piece is dragged, the first virtual piece is located in a tile 1 of the virtual board, and the second virtual piece is located in a tile 2 of the virtual board. The tile 1 is equivalent to the second position, and the tile 2 is equivalent to the first position. If the first virtual piece can be dragged, a finger of a user presses the first virtual piece displayed on the terminal, starts to drag the first virtual piece, and loosens the finger when dragging the first virtual piece to the tile 2. The terminal displays the first virtual piece being placed in the tile 2 and the second virtual piece being moved to the tile 1, thereby implementing the solution of exchanging the positions of the first virtual piece and the second virtual piece.

This embodiment of this application is described using an example in which there is a virtual piece at the position at which the dragging operation ends. However, in another embodiment, operation 1903 does not need to be performed, but another manner is used. That is, in response to the end of the dragging operation, the first virtual piece being placed at the first position is displayed.

In the solutions provided in the embodiments of this application, in response to the dragging operation on the virtual piece on the virtual board, a picture in which the virtual player character drags the virtual piece through a prop can be displayed, so as to reflect the solution in which the virtual player character adjusts the virtual piece layout in the virtual board through the target prop. Movement of the virtual pieces can precisely follow operations of the player, thereby reducing stuttering and delay, providing the player with an exceptionally smooth operational experience, and significantly improving the efficiency of controlling the virtual piece by the player. In addition, the sense of participation of the virtual player character in the process of adjusting the virtual piece layout is enhanced, so that the player can adjust the position of the virtual piece on the virtual board by acting as the virtual player character, thereby improving the interaction effect between the virtual player character and the player, enhancing the sense of immersion of the player, and further improving the player experience.

Based on the embodiments shown in FIG. 16 to FIG. 19, in this embodiment of this application, dragging the virtual piece consumes an energy value, and the virtual piece on the virtual board can be dragged only when the energy value is sufficient. That is, a process of dragging the first virtual piece includes: displaying, in the battle interface in response to the dragging operation on the first virtual piece and when a first energy value is not less than a second energy value, the virtual player character dragging the first virtual piece through the target prop, the first energy value being an energy value currently possessed by the virtual player character, and the second energy value being an energy value consumed by the virtual player character for adjusting a position of the virtual piece.

In this embodiment of this application, adjusting the position of the virtual piece on the virtual board consumes the energy possessed by the virtual player character. When the energy value possessed by the virtual player character is greater than the energy value consumed by adjusting the position of the virtual piece, the energy value currently possessed by the virtual player character can satisfy the consumption of adjusting the position of the virtual piece. Thus, the dragging operation on the first virtual piece can be triggered to adjust the position of the virtual piece on the virtual board, thereby enriching the gameplay. Restrictions are added to the dragging of the virtual piece to affect the virtual piece layout, preventing the virtual piece from being dragged indefinitely, which may affect the game balance, thereby improving the fairness of the game.

In an implementation, the method further includes: reducing, in response to the dragging operation on the first virtual piece and when the first energy value is not less than the second energy value, the energy value possessed by the virtual player character by the second energy value.

In this embodiment of this application, adjusting the position of the virtual piece on the virtual board needs to consume the energy possessed by the virtual player character. When the first virtual piece is dragged, the energy value possessed by the virtual player character is reduced by an energy value consumed for moving the first virtual piece, to ensure the accuracy of the energy value possessed by the virtual player character.

In some embodiments, when placing the first virtual piece at the position at which the dragging operation ends is displayed in the battle interface, the energy value possessed by the virtual player character is reduced by the second energy value.

In this embodiment of this application, when the first virtual piece is placed at the position at which the dragging operation ends, the process of dragging the virtual piece ends, and the energy value possessed by the virtual player character is reduced, to ensure the accuracy of the energy value possessed by the virtual player character.

Based on the embodiments shown in FIG. 16 to FIG. 19, in this embodiment of this application, in the process of using a virtual card by the virtual player character, a process of converting the virtual card into a virtual piece is displayed, and the virtual player character dragging the converted virtual piece through the target prop is displayed. That is, the method further includes: displaying, in a process of dragging the virtual card and when the virtual card enters the virtual board from the hand region, conversion of the virtual card into a third virtual piece, and displaying the virtual player character dragging the third virtual piece through the target prop; and displaying, in response to an end of a dragging operation on the virtual card, the third virtual piece at a third position of the virtual board, the third position being a position at which the dragging operation on the virtual card ends.

In this embodiment of this application, the virtual player character can use the virtual card by dragging the virtual card, so that the virtual card is converted into a virtual piece on the virtual board. In a process of dragging the virtual card in the hand region to the virtual board, once the virtual card enters the virtual board, the virtual card is immediately converted into a virtual piece, the virtual player character dragging, through the target prop, the virtual piece converted from the virtual card is displayed, and a position of the virtual piece converted from the virtual card in the virtual board changes with the dragging operation to improve the display effect of using the virtual card, so that a user can perceive the effect of using the virtual card. Thus, the player can use the virtual card by acting as a virtual player character, thereby improving the interaction effect between the virtual player character and the player, enhancing the sense of immersion of the player, and further improving the player experience.

The virtual card is a piece card, and the piece card is configured for conversion into a virtual piece on the virtual board. The battle interface includes a hand region, and a virtual card possessed by the virtual player character is displayed in the hand region. The position at which the dragging operation on the virtual card ends is located in the virtual board. In this embodiment of this application, when the position at which the dragging operation on the virtual card ends is located in the virtual board, it can be displayed that the virtual piece converted from the virtual card is placed on the virtual board. When the position at which the dragging operation on the virtual card ends is located outside the virtual board, it can be displayed that the virtual card is redisplayed in the hand region, which is equivalent to canceling the operation of using the virtual card.

For example, the terminal displays a virtual card 1 in the hand region, and a finger of the user presses the virtual card 1 and starts to move the virtual card 1, so that in a process of moving the finger, the terminal displays the virtual card 1 moving along with the movement of a pressing position of the finger. If the pressing position enters the virtual board from the hand region, the terminal displays the virtual card 1 changing into a 3D virtual piece, and the 3D virtual piece moving along with the movement of the pressing position in the virtual board. When the pressing position moves to any position of the virtual board, the user loosens the finger, and the terminal places the 3D virtual piece at the pressing position when the user loosens the finger.

Based on the embodiments shown in FIG. 16 to FIG. 19, in this embodiment of this application, in the process of dragging the virtual piece, the virtual piece avoids an existing virtual piece on the virtual board. That is, the method further includes: determining, in response to the dragging operation on the first virtual piece, a first path based on the first position, the second position, and the virtual piece on the virtual board, the first path extending from the first position to the second position, and no virtual piece existing on the first path; and the first position being a starting point of the dragging operation, and the second position being an end point of the dragging operation; and displaying, in the battle interface, the virtual player character dragging the first virtual piece through the target prop according to the first path.

In this embodiment of this application, considering that there are a plurality of virtual pieces on the virtual board, in a process of dragging any virtual piece, a path of the virtual piece extending from the first position to the second position is determined according to a starting point and an end point of the dragging operation and a position of the virtual piece on the virtual board. Thus, in the process of dragging the virtual piece through the dragging operation, the virtual player character dragging the virtual piece for movement through the target prop according to the first path is displayed, so that in the process of dragging the first virtual piece, the first virtual piece can avoid the existing virtual piece on the virtual board, thereby preventing collision between the first virtual piece and another virtual piece on the virtual board. Thus, it is ensured that the process of dragging the first virtual piece matches the dragging operation, thereby ensuring the accuracy of the process of dragging the virtual piece and the picture display effect.

In an implementation, a process of determining the second position includes: predicting, in response to the dragging operation, the second position based on the first position and a dragging direction of the dragging operation.

In this embodiment of this application, in response to the dragging operation, before the dragging operation ends, the end point of the dragging operation is predicted based on the starting point of the dragging operation and the dragging direction of the dragging operation, so that dragging the first virtual piece according to the first path can be displayed in time in the process of triggering the dragging operation, and it is ensured that the process of dragging the first virtual piece keeps consistency with the dragging operation as much as possible, thereby ensuring the picture display effect of the process of dragging the virtual piece.

In an implementation, a process of dragging the first virtual piece includes: predicting, when the virtual piece is moved to the second position, a third position based on the second position and a dragging direction of the dragging operation, the third position being an end point of the dragging operation; determining a second path based on the second position, the third position, and the virtual piece on the virtual board, the second path extending from the second position to the third position, and no virtual piece existing on the second path; and displaying, in the battle interface, the virtual player character dragging the first virtual piece through the target prop according to the second path.

In this embodiment of this application, in response to the dragging operation, before the dragging operation ends, the end point of the dragging operation is predicted multiple times, and the path is determined according to the currently predicted end point to display the dragging of the virtual piece according to the currently determined path. In addition, when the virtual piece is dragged to the end point of the current path, a next end point of the dragging operation is automatically predicted, and a next path is automatically determined to display the dragging of the virtual piece according to the currently determined path. In this way, it can be ensured that the virtual piece on the virtual board can be avoided in the process of dragging the virtual piece, and it can be ensured as much as possible that the picture of dragging the virtual piece is synchronous with the dragging operation. Thus, the player can perceive that the position of the virtual piece on the virtual board changes with the dragging operation triggered by the player, thereby ensuring the accuracy of the process of dragging the virtual piece and the picture display effect, and further improving the player experience.

Based on the embodiments shown in FIG. 16 to FIG. 19, in this embodiment of this application, in the process of dragging the virtual piece, the virtual piece avoids an existing virtual piece on the virtual board. That is, the method further includes: displaying, in the battle interface in response to the dragging operation on the first virtual piece, the virtual player character dragging the first virtual piece through the target prop according to the first path, the first path being determined based on a fourth position, the second position, and the virtual piece on the virtual board; the first path extending from the second position to the fourth position; and no virtual piece existing on the first path, and the second position being a starting point of the dragging operation.

The second position is equivalent to a position at which the first virtual piece is located before the first virtual piece is dragged, and the fourth position is equivalent to a predicted end point of the dragging operation. If the dragging operation ends when the first virtual piece is dragged to the fourth position, the fourth position is equivalent to the first position in the embodiments shown in FIG. 16 to FIG. 19.

In this embodiment of this application, considering that there are a plurality of virtual pieces on the virtual board, in a process of dragging any virtual piece, a path of the virtual piece extending from the starting point to the predicted end point is determined according to the starting point and the predicted end point of the dragging operation and a position of the virtual piece on the virtual board. Thus, in the process of dragging the virtual piece through the dragging operation, the virtual player character dragging the virtual piece for movement through the target prop according to the path is displayed, so that in the process of dragging the first virtual piece, the first virtual piece can avoid the existing virtual piece on the virtual board, thereby preventing collision between the first virtual piece and another virtual piece on the virtual board. Thus, it is ensured that the process of dragging the first virtual piece matches the dragging operation, thereby ensuring the accuracy of the process of dragging the virtual piece and the picture display effect.

For example, the virtual board includes a plurality of tile positions, and the second position and the fourth position are different tiles in the virtual board. The second position corresponds to a tile 1, and the fourth position corresponds to a tile 2. The first path uses the tile 1 as a starting point and the tile 2 as an end point, and can reflect tiles through which the first virtual piece needs to pass on the virtual board from the tile 1 to the tile 2.

In an implementation, a process of determining the first path is implemented by the terminal or the server.

In this embodiment of this application, the terminal can determine the first path according to the position at which the first virtual piece is located before the first virtual piece is dragged and the fourth position. Alternatively, the terminal transmits, in response to the dragging operation on the first virtual piece, a dragging instruction to the server. The server determines the first path based on the dragging instruction and transmits information of the first path to the terminal. The terminal receives the information of the first path, and displays the virtual player character dragging the first virtual piece through the target prop according to the first path indicated by the information.

In an implementation, the virtual board includes a plurality of tiles, and the second position and the fourth position are two different tiles of the plurality of tiles. The process of determining the first path includes: traversing, based on the tiles where the virtual pieces on the virtual board are located, the second position, and the fourth position, the tiles in the virtual board from the second position to obtain at least one path, and determining a shortest path among the at least one path as the first path.

In this embodiment of this application, the virtual board includes a plurality of tiles, and each tile can hold one virtual piece. In the process of dragging the first virtual piece, the first virtual piece can only be moved from a current tile to an adjacent tile. In this case, starting from the second position and with reference to the fourth position, a tile close to the fourth position and having no virtual piece is determined from tiles around the second position. Then, a tile close to the fourth position and having no virtual piece is determined from tiles around the determined tile. The rest can be deduced by analogy. The determined tiles form a path extending from the second position to the fourth position, i.e., the first path.

In an implementation, a process of determining the second position includes: predicting, in response to the dragging operation, the fourth position based on the second position and a dragging direction of the dragging operation.

In this embodiment of this application, in response to the dragging operation, before the dragging operation ends, the end point of the dragging operation is predicted based on the starting point of the dragging operation and the dragging direction of the dragging operation, so that dragging the first virtual piece according to the first path can be displayed in time in the process of triggering the dragging operation, and it is ensured that the process of dragging the first virtual piece keeps consistency with the dragging operation as much as possible, thereby ensuring the picture display effect of the process of dragging the virtual piece.

In some embodiments, the virtual board includes a plurality of tiles, and the second position and the fourth position are two different tiles of the plurality of tiles. The process of predicting the fourth position includes: determining, from tiles around the second position, a tile in a dragging direction as a first tile; and determining, from tiles around an i^{th} tile, a tile in the dragging direction as an (i+1)^{th} tile, and determining a determined n^{th} tile as the fourth position. i is an integer greater than 0, and n is an integer greater than 1.

In an implementation, the process of dragging the first virtual piece includes: displaying, in the battle interface in response to the dragging operation on the first virtual piece, the virtual player character dragging the first virtual piece through the target prop according to the first path; and displaying, in the battle interface when the first virtual piece is moved to the second position, the virtual player character dragging the first virtual piece through the target prop according to a second path, the second path being determined based on the fourth position, a fifth position, and the virtual piece on the virtual board; the second path extending from the fourth position to the fifth position; and no virtual piece existing on the second path.

In this embodiment of this application, if the dragging operation does not end after the first virtual piece is dragged to the fourth position and the dragging is continued, a next dragging path continues to be predicted. In response to the dragging operation, before the dragging operation ends, the end point of the dragging operation is predicted multiple times, and the path is determined according to the currently predicted end point to display the dragging of the virtual piece according to the currently determined path. In addition, when the virtual piece is dragged to the end point of the current path, a next end point of the dragging operation is automatically predicted, and a next path is automatically determined to display the dragging of the virtual piece according to the currently determined path. In this way, it can be ensured that the virtual piece on the virtual board can be avoided in the process of dragging the virtual piece, and it can be ensured as much as possible that the picture of dragging the virtual piece is synchronous with the dragging operation. Thus, the player can perceive that the position of the virtual piece on the virtual board changes with the dragging operation triggered by the player, thereby ensuring the accuracy of the process of dragging the virtual piece and the picture display effect, and further improving the player experience.

In this embodiment of this application, the fourth position is different from the first position in the embodiments shown in FIG. 16 to FIG. 19. Before the dragging operation ends, the end point of the dragging operation is predicted multiple times, and a path is determined according to the currently predicted end point to display the dragging of the first virtual piece according to the currently determined path. In addition, the position at which the first virtual piece is located when the dragging operation ends is the first position.

For example, in response to the dragging operation on the first virtual piece, the virtual player character dragging the first virtual piece through the target prop according to the first path is displayed, the first path extending from the second position to the fourth position. When the first virtual piece moves to the fourth position, the virtual player character dragging the first virtual piece through the target prop according to the second path is displayed, the second path extending from the fourth position to the fifth position. If the dragging operation ends when the first virtual piece is dragged to the fifth position, the fifth position is equivalent to the first position in the embodiments shown in FIG. 16 to FIG. 19. If the dragging operation does not end when the first virtual piece is dragged to the fifth position, the virtual player character dragging the first virtual piece through the target prop according to a third path is displayed, the third path extending from the fifth position to a sixth position. The rest can be deduced by analogy. The position at which the first virtual piece is located when the dragging operation ends is the first position.

In an implementation, a process of dragging the first virtual piece includes: predicting, when the first virtual piece is moved to the fourth position, the fifth position based on the fourth position and a dragging direction of the dragging operation.

In this embodiment of this application, when the virtual piece is moved to the fourth position, if the dragging operation does not end yet, the end point of the dragging operation is predicted again based on the current position of the first virtual piece and the dragging direction of the dragging operation, so that dragging the first virtual piece according to the second path can be displayed in time in the process of triggering the dragging operation, and it is ensured that the process of dragging the first virtual piece keeps consistency with the dragging operation as much as possible, thereby ensuring the picture display effect of the process of dragging the virtual piece.

The process of predicting the fifth position is the same as the foregoing process of predicting the fourth position, and details are not described herein again.

Based on the embodiments shown in FIG. 16 to FIG. 19, the embodiments of this application further provide a flowchart of dragging a virtual piece. As shown in FIG. 20, the method includes the following operations.

2001: A player selects a virtual piece for dragging.

2002: A terminal determines whether the virtual piece can be dragged, if “yes”, plays a third animation on the virtual piece based on a player character type, and if “no”, prompts that the virtual piece cannot be dragged.

2003: The player, in a process of dragging the virtual piece, keeps playing the third animation if the player does not release the virtual piece.

2004: The player drags the virtual piece to a target position, releases the virtual piece, and plays, based on the player character type, an animation of placing the virtual piece on the virtual piece. If there is a virtual piece at the target position, this virtual piece exchanges positions with the virtual piece at the target position.

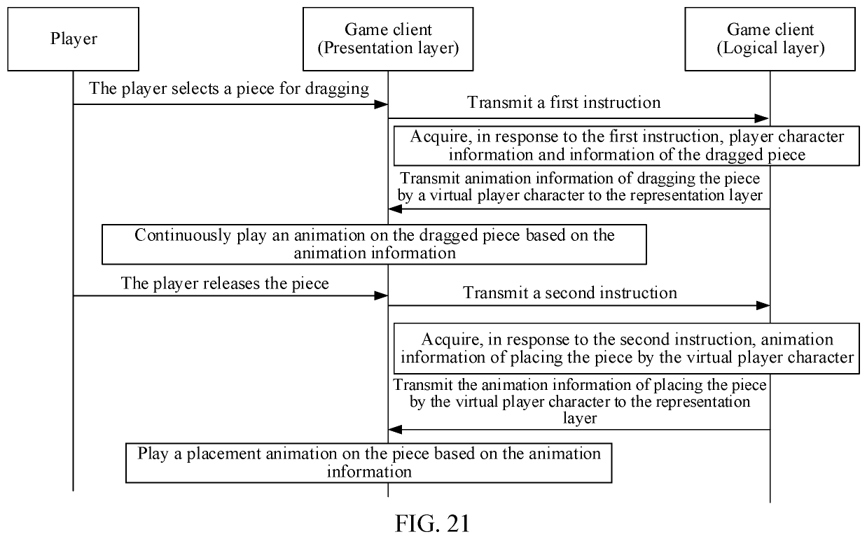

Based on the embodiments shown in FIG. 16 to FIG. 19, the embodiments of this application further provide a flowchart of dragging a virtual piece. As shown in FIG. 21, the method includes the following operations.

2101: A player selects a virtual piece for dragging, and a terminal transmits a first instruction to a logical layer of a game client through a presentation layer of the game client.

2102: The terminal acquires, in response to the first instruction, player character information and information of the dragged piece through the logical layer, acquires, based on the player character information and the piece information, animation information of dragging the virtual piece by a virtual player character, and transmits the animation information of dragging the virtual piece by the virtual player character to the representation layer.

2103: The terminal receives, through the representation layer, the animation information transmitted by the logical layer, and continuously plays an animation on the dragged virtual piece based on the animation information to reflect that the virtual player character drags the virtual piece through a target prop.

2104: The player places the virtual piece at a target position, and the terminal transmits a second instruction to the logical layer through the representation layer.

2104: The terminal receives, through the logical layer, the second instruction transmitted by the representation layer, acquires, in response to the second instruction, animation information of placing the virtual piece by the virtual player character, and transmits the animation information of placing the virtual piece by the virtual player character to the representation layer.

2105: The terminal receives, through the representation layer, the animation information transmitted by the logical layer, and plays a placement animation on the virtual piece based on the animation information.

This embodiment of this application provides an expression manner in which the virtual player character drags the virtual piece using a prop. When the player lays out and drags the virtual piece, the target prop of the virtual player character appears on a model of the virtual piece, showing that the virtual player character is dragging the virtual piece. In addition, this expression manner is correspondingly designed based on the target prop of the virtual player character, and a corresponding dragging expression is played using a feature prop of the virtual player character, so that when the virtual piece is dragged through the target prop, an effect of first picking up the virtual piece and then moving it can be reflected. When the player drags the virtual piece, a corresponding picture is displayed to highlight that the virtual player character is dragging and moving the virtual piece, so that the player can adjust the position of the virtual piece on the virtual board by acting as the virtual player character, and can perceive the existence of the virtual player character to strengthen the player's sense of role-playing and immersion as much as possible, thereby improving the interaction effect between the virtual player character and the player and further improving the player experience.

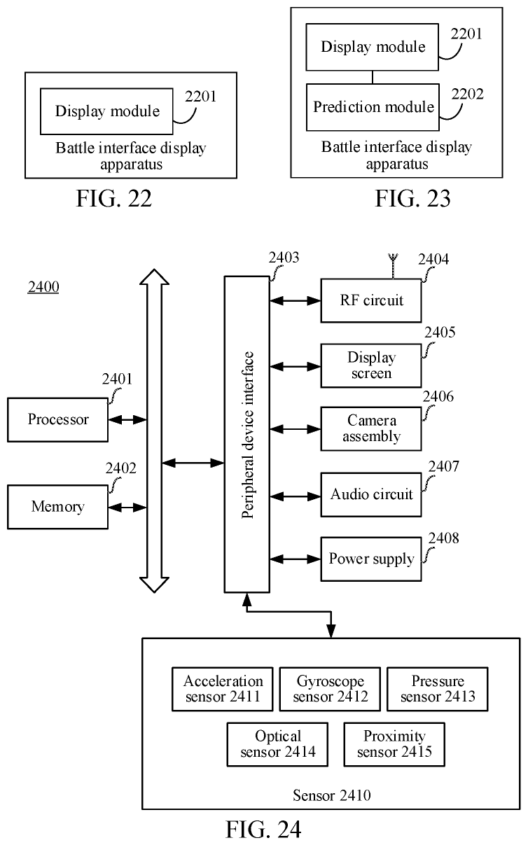

FIG. 22 is a schematic structural diagram of a battle interface display apparatus according to an embodiment of this application. As shown in FIG. 22, the apparatus includes:
a display module 2201, configured to display a battle interface of a round-based board game, a virtual board and a virtual player character being displayed in the battle interface, and a first virtual piece of the virtual player character being displayed on the virtual board;
the display module 2201 being further configured to display, in the battle interface in response to a dragging operation on the first virtual piece, the virtual player character dragging the first virtual piece through a target prop; and
the display module 2201 being further configured to display, in response to an end of the dragging operation, the first virtual piece at a first position of the virtual board, the first position being a position at which the dragging operation ends.

In an implementation, the battle interface includes a player character display area, the player character display area is located outside the virtual board, and the virtual player character is displayed in the player character display area. The display module 2201 is configured to display, on the virtual board in response to the dragging operation on the first virtual piece, the target prop dragging the first virtual piece, and play a first animation in the player character display area, the first animation being configured for displaying a process in which the virtual player character drags the first virtual piece through the target prop.

In another implementation, the display module 2201 is further configured to display, in the process in which the virtual player character drags the first virtual piece through the target prop, a floating effect around the first virtual piece, the floating effect indicating that the first virtual piece floats above the virtual board.

In another implementation, the display module 2201 is configured to play, in response to the end of the dragging operation, a second animation at the first position, the second animation being configured for displaying a process of placing the first virtual piece at the first position.

In another possible implementation, the display module 2201 is configured to display, in response to the end of the dragging operation and when a second virtual piece is already placed at the first position, the first virtual piece at the first position, and display the second virtual piece at a second position, the second position being a position at which the first virtual piece is located before the first virtual piece is dragged.

In another implementation, the display module 2201 is configured to display, in the battle interface in response to the dragging operation on the first virtual piece and when the first virtual piece satisfies a dragging condition, the virtual player character dragging the first virtual piece through the target prop.

In another possible implementation, the display module 2201 is configured to display, in the battle interface in response to the dragging operation on the first virtual piece and when a first energy value is not less than a second energy value, the virtual player character dragging the first virtual piece through the target prop, the first energy value being an energy value currently possessed by the virtual player character, and the second energy value being an energy value consumed by the virtual player character for adjusting a piece position.

In another implementation, the battle interface includes a hand region, and a virtual card possessed by the virtual player character is displayed in the hand region. The display module 2201 is further configured to display, in a process of dragging the virtual card and when the virtual card enters the virtual board from the hand region, conversion of the virtual card into a third virtual piece, and display the virtual player character dragging the third virtual piece through the target prop; and display, in response to an end of a dragging operation on the virtual card, the third virtual piece at a third position of the virtual board, the third position being a position at which the dragging operation on the virtual card ends.

In another possible implementation, the display module 2201 is configured to determine, in response to the dragging operation on the first virtual piece, a first path based on the first position, the second position, and the virtual piece on the virtual board, the first path extending from the first position to the second position, and no virtual piece existing on the first path; and the first position being a starting point of the dragging operation, and the second position being an end point of the dragging operation; and display, in the battle interface, the virtual player character dragging the first virtual piece through the target prop according to the first path.

In another implementation, as shown in FIG. 23, the apparatus further includes:
a prediction module 2202, configured to predict, in response to the dragging operation, the second position based on the first position and a dragging direction of the dragging operation.

In another possible implementation, the prediction module 2202 is further configured to predict, when the piece is moved to the second position, a third position based on the second position and a dragging direction of the dragging operation, the third position being an end point of the dragging operation; and determine a second path based on the second position, the third position, and the virtual piece on the virtual board, the second path extending from the second position to the third position, and no virtual piece existing on the second path.

The display module 2201 is further configured to display, in the battle interface, the virtual player character dragging the first virtual piece through the target prop according to the second path.

In another possible implementation, the display module 2201 is configured to display, in the battle interface in response to the dragging operation on the first virtual piece, the virtual player character dragging the first virtual piece through the target prop according to a first path, the first path being determined based on a fourth position, the second position, and a piece on the virtual board; the first path extending from the second position to the fourth position; and no piece existing on the first path, and the second position being a starting point of the dragging operation.

In another implementation, as shown in FIG. 23, the apparatus further includes:
the prediction module 2202, configured to predict, in response to the dragging operation, the fourth position based on the second position and a dragging direction of the dragging operation.

In another possible implementation, the display module 2201 is further configured to display, in the battle interface in response to the dragging operation on the first virtual piece and when the first virtual piece is moved to the second position, the virtual player character dragging the first virtual piece through the target prop according to a second path, the second path being determined based on the fourth position, a fifth position, and the piece on the virtual board; the second path extending from the fourth position to the fifth position; and no piece existing on the second path.

In another implementation, as shown in FIG. 23, the apparatus further includes:
the prediction module 2202, configured to predict, when the first virtual piece is moved to the fourth position, the fifth position based on the fourth position and a dragging direction of the dragging operation.

The battle interface display apparatus provided in the foregoing embodiment is described only using the division of the foregoing functional modules as an example. In practical application, the foregoing functions may be allocated to and completed by different functional modules as required. That is, an internal structure of a computer device is divided into different functional modules to complete all or some of the functions described above. In addition, the battle interface display apparatus provided in the foregoing embodiment belongs to the same idea as the battle interface display method embodiment. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. Details of a specific implementation process may refer to the method embodiment and will not be described herein again.

The embodiments of this application further provide a computer device, including a processor and a memory, the memory having at least one computer program stored therein, and the at least one computer program being loaded and executed by the processor to implement the operations performed in the battle interface display method in the foregoing embodiments.

The computer device is provided as a terminal. FIG. 24 is a structural block diagram of a terminal 2400 according to an exemplary embodiment of this application. The terminal 2400 includes a processor 2401 and a memory 2402.

The processor 2401 may include one or more processing cores, for example, a 4-core processor or an 8-core processor. The processor 2401 may be implemented in at least one hardware form of digital signal processing (DSP), a field-programmable gate array (FPGA), and a programmable logic array (PLA). The processor 2401 may further include a main processor and a coprocessor. The main processor is a processor configured to process data in an awake state and is alternatively referred to as a central processing unit (CPU). The coprocessor is a low-power-consumption processor configured to process data in a standby state. In some embodiments, the processor 2401 may be integrated with a graphics processing unit (GPU). The GPU is configured to render and draw content that needs to be displayed on a display screen. In some embodiments, the processor 2401 may further include an AI processor. The AI processor is configured to process computing operations related to machine learning.

The memory 2402 may include one or more computer-readable storage media. The computer-readable storage medium may be non-transient. The memory 2402 may further include a high-speed random access memory and a non-volatile memory, for example, one or more disk storage devices and flash storage devices. In some embodiments, the non-transient computer-readable storage medium in the memory 2402 is configured to store at least one computer program. The at least one computer program is executed by the processor 2401 to implement the battle interface display method provided in the method embodiments of this application.

In some embodiments, the terminal 2400 may alternatively include: a peripheral device interface 2403 and at least one peripheral device. The processor 2401, the memory 2402, and the peripheral device interface 2403 may be connected through a bus or a signal line. Each peripheral device may be connected to the peripheral device interface 2403 through a bus, a signal line, or a circuit board. Specifically, the peripheral device includes at least one of a radio frequency (RF) circuit 2404, a display screen 2405, a camera assembly 2406, an audio circuit 2407, and a power supply 2408.

The peripheral device interface 2403 may be configured to connect at least one I/O-related peripheral device to the processor 2401 and the memory 2402. In some embodiments, the processor 2401, the memory 2402, and the peripheral device interface 2403 are integrated on a same chip or circuit board. In other embodiments, any one or two of the processor 2401, the memory 2402, and the peripheral device interface 2403 may be implemented on a single chip or circuit board. This is not limited in this embodiment.

The RF circuit 2404 is configured to receive and transmit an RF signal, referred to as an electromagnetic signal. The RF circuit 2404 communicates with a communication network and other communication devices through the electromagnetic signal. The RF circuit 2404 converts an electrical signal into an electromagnetic signal for transmission, or converts a received electromagnetic signal into an electrical signal. In some embodiments, the RF circuit 2404 includes: an antenna system, an RF transceiver, one or more amplifiers, a tuner, an oscillator, a digital signal processor, a codec chipset, a user identity module card, and the like. The RF circuit 2404 may communicate with another terminal through at least one wireless communication protocol. The wireless communication protocol includes, but is not limited to, a world wide web, a metropolitan area network, an intranet, various generations of mobile communication networks (2G, 3G, 4G, and 5G), a wireless local area network, and/or a wireless fidelity (WiFi) network. In some embodiments, the RF circuit 2404 may further include a circuit related to near field communication (NFC). This is not limited in this application.

The display screen 2405 is configured to display a UI. The UI may include graphics, text, icons, videos, and any combination thereof. When the display screen 2405 is a touch display screen, the display screen 2405 further has a capability of collecting a touch signal on or above a surface of the display screen 2405. The touch signal may be inputted to the processor 2401 as a control signal for processing. In this case, the display screen 2405 may be further configured to provide a virtual button and/or a virtual keyboard, referred to as a soft button and/or a soft keyboard. In some embodiments, there may be one display screen 2405, provided on a front panel of the terminal 2400. In other embodiments, there may be at least two display screens 2405, respectively provided on different surfaces of the terminal 2400 or designed in a foldable shape. In other embodiments, the display screen 2405 may be a flexible display screen, provided on a curved surface or a folded surface of the terminal 2400. Even, the display screen 2405 may be further provided in a non-rectangular irregular pattern, i.e., a special-shaped screen. The display screen 2405 may be prepared using materials such as a liquid crystal display (LCD) and an organic light-emitting diode (OLED).

The camera assembly 2406 is configured to collect images or videos. In some embodiments, the camera assembly 2406 includes a front camera and a rear camera. The front camera is provided on the front panel of the terminal, and the rear camera is provided on a back surface of the terminal. In some embodiments, there are at least two rear cameras, which are any of main cameras, depth-of-field cameras, wide-angle cameras, and telephoto cameras, to achieve a background blur function through fusion of the main camera and the depth-of-field camera, panoramic photographing and virtual reality (VR) photographing functions through fusion of the main camera and the wide-angle camera, or other fusion photographing functions. In some embodiments, the camera assembly 2406 may further include a flash. The flash may be a single-color temperature flash, or may be a dual-color temperature flash. The dual-color temperature flash refers to a combination of a warm-light flash and a cold-light flash, and may be configured for light compensation under different color temperatures.

The audio circuit 2407 may include a microphone and a speaker. The microphone is configured to collect sound waves of a user and an environment, and convert the sound waves into electrical signals to input to the processor 2401 for processing, or input to the RF circuit 2404 for implementing voice communication. For the purpose of stereo collection or noise reduction, there may be a plurality of microphones, provided at different parts of the terminal 2400. The microphone may further be an array microphone or an omni-directional acquisition type microphone. The speaker is configured to convert the electrical signals from the processor 2401 or the RF circuit 2404 into sound waves. The speaker may be a conventional film speaker, or may be a piezoelectric ceramic speaker. When the speaker is the piezoelectric ceramic speaker, the speaker may not only convert the electrical signal into a sound wave audible to the human being, but also convert the electrical signal into a sound wave inaudible to the human being, for ranging and other purposes. In some embodiments, the audio circuit 2407 may further include a headphone jack.

The power supply 2408 is configured to supply power to assemblies in the terminal 2400. The power supply 2408 may be an alternating current, a direct current, a disposable battery, or a rechargeable battery. When the power supply 2408 includes a rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may be further configured to support a fast charging technology.

In some embodiments, the terminal 2400 further includes one or more sensors 2410. The one or more sensors 2410 include, but are not limited to, an acceleration sensor 2411, a gyroscope sensor 2412, a pressure sensor 2413, an optical sensor 2414, and a proximity sensor 2415.

The acceleration sensor 2411 may detect magnitudes of accelerations on three coordinate axes of a coordinate system established with the terminal 2400. For example, the acceleration sensor 2411 may be configured to detect components of gravity acceleration on the three coordinate axes. The processor 2401 may control the display screen 2405 to display the UI in a landscape view or a portrait view according to a gravity acceleration signal collected by the acceleration sensor 2411. The acceleration sensor 2411 may be further configured to collect motion data of a game or a user.

The gyroscope sensor 2412 may detect a body direction and a rotation angle of the terminal 2400. The gyroscope sensor 2412 may cooperate with the acceleration sensor 2411 to collect a 3D action by the user on the terminal 2400. The processor 2401 may implement the following functions according to the data collected by the gyroscope sensor 2412: action sensing (such as changing the UI according to a tilt operation of the user), image stabilization during photographing, game control, and inertial navigation.

The pressure sensor 2413 may be provided at a side frame of the terminal 2400 and/or a lower layer of the display screen 2405. When the pressure sensor 2413 is provided at the side frame of the terminal 2400, a holding signal of the user on the terminal 2400 may be detected. The processor 2401 performs left and right hand recognition or a quick operation according to the holding signal collected by the pressure sensor 2413. When the pressure sensor 2413 is provided on the low layer of the display screen 2405, the processor 2401 controls an operable control on the UI according to a pressure operation of the user on the display screen 2405. The operable control includes at least one of a button control, a scroll-bar control, an icon control, and a menu control.

The optical sensor 2414 is configured to collect ambient light intensity. In an embodiment, the processor 2401 may control the display brightness of the display screen 2405 according to the ambient light intensity collected by the optical sensor 2414. Specifically, when the ambient light intensity is high, the display brightness of the display screen 2405 is increased. When the ambient light intensity is low, the display brightness of the display screen 2405 is decreased. In another embodiment, the processor 2401 may further dynamically adjust photographing parameters of the camera assembly 2406 according to the ambient light intensity collected by the optical sensor 2414.

The proximity sensor 2415, alternatively referred to as a distance sensor, is provided on the front panel of the terminal 2400. The proximity sensor 2415 is configured to collect a distance between the user and a front surface of the terminal 2400. In an embodiment, when the proximity sensor 2415 detects that the distance between the user and the front surface of the terminal 2400 gradually decreases, the display screen 2405 is controlled by the processor 2401 to switch from a screen-on state to a screen-off state. When the proximity sensor 2415 detects that the distance between the user and the front surface of the terminal 2400 gradually increases, the display screen 2405 is controlled by the processor 2401 to switch from the screen-off state to the screen-on state.

A person skilled in the art may understand that the structure shown in FIG. 24 does not constitute any limitation on the terminal 2400, and the terminal 2400 may include more assemblies or fewer assemblies than those shown in the figure, or some assemblies may be combined, or a different assembly deployment may be used.

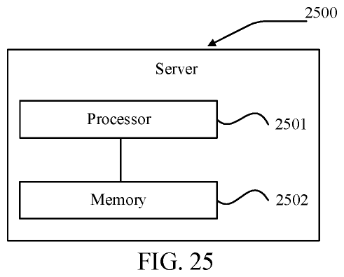

The computer device is provided as a server. FIG. 25 is a schematic structural diagram of a server according to an embodiment of this application. A server 2500 may vary significantly due to different configurations or performances and may include one or more CPUs 2501 and one or more memories 2502. The memory 2502 has at least one computer program stored therein. The at least one computer program is loaded and executed by the processor 2501 to implement the method provided in the foregoing method embodiments. The server may further have components such as a wired or wireless network interface, a keyboard, and an I/O interface for inputting and outputting. The server may further include other components configured to implement device functions, and details are not described herein.

The embodiments of this application further provide a computer-readable storage medium, having at least one computer program stored therein, and the at least one computer program being loaded and executed by a processor to implement the operations performed in the battle interface display method in the foregoing embodiments.

The embodiments of this application further provide a computer program product, including a computer program which, when executed by a processor, implements the operations performed in the battle interface display method in the foregoing embodiments.

A person skilled in the art may understand that all or some of the operations of the foregoing embodiments may be implemented by hardware, or may be implemented by a program instructing relevant hardware. The program may be stored in a computer-readable storage medium. The foregoing storage medium may be a read-only memory, a magnetic disk, an optical disc, or the like.

The above descriptions are merely exemplary embodiments of the embodiments of this application, and are not intended to limit the embodiments of this application. Any modification, equivalent replacement, improvement, or the like made within the spirit and principle of the embodiments of this application falls within the protection scope of this application.

What is claimed is:

1. A battle interface display method performed by a computer device, the method comprising:
displaying a battle interface of a round-based board game, the battle interface comprising a virtual board and a player character display area including a virtual player character, and a first virtual piece of the virtual player character being displayed on the virtual board;
in response to a dragging operation on the first virtual piece, rendering a first animation in which the virtual player character drags the first virtual piece through a target prop in the player character display area in parallel to the target prop dragging the first virtual piece on the virtual board; and
displaying, in response to an end of the dragging operation, the first virtual piece at a first position of the virtual board, the first position being a position at which the dragging operation ends.

2. The method according to claim 1, further comprising:
displaying, while the target prop dragging the first virtual piece on the virtual board, a floating effect around the first virtual piece, the floating effect indicating that the first virtual piece floats above the virtual board.

3. The method according to claim 1, wherein the displaying, in response to an end of the dragging operation, the first virtual piece at a first position of the virtual board comprises:
playing a second animation at the first position, the second animation being configured for displaying a process of placing the first virtual piece at the first position.

4. The method according to claim 1, wherein the displaying, in response to an end of the dragging operation, the first virtual piece at a first position of the virtual board comprises:
when a second virtual piece is already placed at the first position, placing the first virtual piece at the first position and moving the second virtual piece to a second position occupied by the first virtual piece before the first virtual piece is dragged.

5. The method according to claim 1, wherein the virtual player character is enabled to drag the first virtual piece through the target prop in the player character display area when a first energy value is not less than a second energy value, the first energy value being an energy value currently possessed by the virtual player character, and the second energy value being an energy value consumed by the virtual player character for adjusting a piece position.

6. The method according to claim 1, wherein the battle interface comprises a hand region, and a virtual card possessed by the virtual player character is displayed in the hand region; and the method further comprises:
when the virtual card enters the virtual board from the hand region, converting the virtual card into a third virtual piece, and displaying the virtual player character dragging the third virtual piece through the target prop; and
in response to an end of a dragging operation on the virtual card, displaying the third virtual piece at a third position of the virtual board, the third position being a position at which the dragging operation on the virtual card ends.

7. The method according to claim 1, wherein the rendering a first animation in which the virtual player character drags the first virtual piece through a target prop in the player character display area in parallel to the target prop dragging the first virtual piece on the virtual board comprises:
displaying the virtual player character dragging the first virtual piece through the target prop according to a first path from a second position occupied by the first virtual piece to a fourth position.

8. The method according to claim 7, wherein, before displaying the virtual player character dragging the first virtual piece through the target prop according to the first path, the method further comprises:
predicting the fourth position based on the second position and a dragging direction of the dragging operation.

9. A computer device, comprising a processor and a memory, the memory having at least one computer program stored therein, and the at least one computer program, when being loaded and executed by the processor, causing the computer device to implement a battle interface display method including:
displaying a battle interface of a round-based board game, the battle interface comprising a virtual board and a player character display area including a virtual player character, and a first virtual piece of the virtual player character being displayed on the virtual board;
in response to a dragging operation on the first virtual piece, rendering a first animation in which the virtual player character drags the first virtual piece through a target prop in the player character display area in parallel to the target prop dragging the first virtual piece on the virtual board; and
displaying, in response to an end of the dragging operation, the first virtual piece at a first position of the virtual board, the first position being a position at which the dragging operation ends.

10. The computer device according to claim 9, wherein the method further comprises:
displaying, while the target prop dragging the first virtual piece on the virtual board, a floating effect around the first virtual piece, the floating effect indicating that the first virtual piece floats above the virtual board.

11. The computer device according to claim 9, wherein the displaying, in response to an end of the dragging operation, the first virtual piece at a first position of the virtual board comprises:
playing a second animation at the first position, the second animation being configured for displaying a process of placing the first virtual piece at the first position.

12. The computer device according to claim 9, wherein the displaying, in response to an end of the dragging operation, the first virtual piece at a first position of the virtual board comprises:
when a second virtual piece is already placed at the first position, placing the first virtual piece at the first position and moving the second virtual piece to a second position occupied by the first virtual piece before the first virtual piece is dragged.

13. The computer device according to claim 9, wherein the virtual player character is enabled to drag the first virtual piece through the target prop in the player character display area when a first energy value is not less than a second energy value, the first energy value being an energy value currently possessed by the virtual player character, and the second energy value being an energy value consumed by the virtual player character for adjusting a piece position.

14. The computer device according to claim 9, wherein the battle interface comprises a hand region, and a virtual card possessed by the virtual player character is displayed in the hand region; and the method further comprises:
when the virtual card enters the virtual board from the hand region, converting the virtual card into a third virtual piece, and displaying the virtual player character dragging the third virtual piece through the target prop; and
in response to an end of a dragging operation on the virtual card, displaying the third virtual piece at a third position of the virtual board, the third position being a position at which the dragging operation on the virtual card ends.

15. The computer device according to claim 9, wherein the rendering a first animation in which the virtual player character drags the first virtual piece through a target prop in the player character display area in parallel to the target prop dragging the first virtual piece on the virtual board comprises:
displaying the virtual player character dragging the first virtual piece through the target prop according to a first path from a second position occupied by the first virtual piece to a fourth position.

16. The computer device according to claim 15, wherein the method further comprises:
predicting the fourth position based on the second position and a dragging direction of the dragging operation before displaying the virtual player character dragging the first virtual piece through the target prop according to the first path.

17. A non-transitory computer-readable storage medium, having at least one computer program stored therein, and the at least one computer program, when being loaded and executed by a processor of a computer device, causing the computer device to implement a battle interface display method including:
displaying a battle interface of a round-based board game, the battle interface comprising a virtual board and a player character display area including a virtual player character, and a first virtual piece of the virtual player character being displayed on the virtual board;
in response to a dragging operation on the first virtual piece, rendering a first animation in which the virtual player character drags the first virtual piece through a target prop in the player character display area in parallel to the target prop dragging the first virtual piece on the virtual board; and
displaying, in response to an end of the dragging operation, the first virtual piece at a first position of the virtual board, the first position being a position at which the dragging operation ends.

18. The non-transitory computer-readable storage medium according to claim 17, wherein the method further comprises:
displaying, while the target prop dragging the first virtual piece on the virtual board, a floating effect around the first virtual piece, the floating effect indicating that the first virtual piece floats above the virtual board.

19. The non-transitory computer-readable storage medium according to claim 17, wherein the displaying, in response to an end of the dragging operation, the first virtual piece at a first position of the virtual board comprises:
playing a second animation at the first position, the second animation being configured for displaying a process of placing the first virtual piece at the first position.

20. The non-transitory computer-readable storage medium according to claim 17, wherein the displaying, in response to an end of the dragging operation, the first virtual piece at a first position of the virtual board comprises:
when a second virtual piece is already placed at the first position, placing the first virtual piece at the first position and moving the second virtual piece to a second position occupied by the first virtual piece before the first virtual piece is dragged.
